(19) United States
(12) Patent Application Publication
(10) Pub. No.: US 2023/0310980 A1
(43) Pub. Date: Oct. 5, 2023

(54) GAME CONTROLLER WITH DISPLACEMENT DETECTING DEVICE AND DISPLACEMENT DETECTING DEVICE THEREOF

(71) Applicant: Haitao Zhou, Chongqing (CN)

(72) Inventor: Haitao Zhou, Chongqing (CN)

(21) Appl. No.: 18/129,060

(22) Filed: Mar. 30, 2023

(30) Foreign Application Priority Data
Mar. 31, 2022 (CN) 2022103980097
Mar. 23, 2023 (CN) 2023205956995

(51) Int. Cl. A63F 13/21; A63F 13/22; A63F 13/24; A63F 13/358

(52) U.S. Cl. CPC A63F 13/21; A63F 13/22; A63F 13/24; A63F 13/358

(57) ABSTRACT

A game controller with a displacement detection device comprises a controller and a displacement detection device. The displacement detection device further defines a detection channel. The displacement detection device comprises a detection module and an operating element, wherein the detection module detects the displacement of the operating element in the detection channel to control the movement of a control target.

### CROSS REFERENCE OF RELATED APPLICATION

This is a non-provisional application that claims the benefit of priority under 35 U.S.C. § 119 to Chinese application, application number 202210398009.7, filed Mar. 31, 2022, application number 202320595699.5, filed Mar. 23, 2023, which entire contents are expressly incorporated herein by references.

### BACKGROUND OF THE INVENTION

### Field of Invention

The invention relates to a game controller, and more particular to a game controller with displacement detecting device, a method of using the game controller and a displacement detection device of the game controller.

### Field of Invention

Gamepads and mice are two of the most common control devices of computer and video game, both used to control an target image on a screen driven by a computer device. Gamepads can be divided into one-handed gamepads and two-handed gamepads. FIG. 1 of the drawing is a common one-handed gamepad. The gamepad's housing is suitable for one-handed grip, and has two input devices, joystick module and button module. When in use, the gamepad is connected to a computer, such as a PC, which drives a screen that can also run video games and display the game content. The user controls the target image on the screen by a joystick and buttons. Target images comprise cursor (mouse pointer), front sight of weapon, game character, field of view, etc. Controlling the movement of the target image on the screen is the most common control requirement, and it is best to move quickly and accurately. The present gamepad control the target image to move around the screen by a joystick, but it's can't be both fast and precise that controlling the target image to move around the screen by a joystick.

For example, to control the movement of the cursor on the screen, the user pushes the joystick on the gamepad in a certain direction, and the cursor on the screen moves in that direction, the user Releases the joystick on the gamepad, and the cursor stops moving. For example, the cursor is located at point A on the screen and needs to be moved to point B, the user pushes the joystick in the direction of point B. When the cursor reaches point B, the user releases the joystick and the cursor stays at point B, the moving process is complete. The greater the Angle at which the user pushes the joystick, the faster the cursor moves, making it impossible for the user to control the cursor's movement with both speed and precision. For example, when the user pushes the joystick at a large Angle in one direction, the cursor moves quickly. At the same time, it is difficult for the user to grasp the time to release the joystick, which makes it difficult for the cursor to stay in the desired position. Often, the movement distance is either insufficient or too much. If you nudge the joystick and the cursor moves slowly, it's easier to stay where you want it on the screen, allowing you to move the cursor precisely, but not quickly.

The mouse is another common control device of computer and video game, and is characterized by the ability to quickly and accurately control the movement of the target image on the screen. This is because both optical and mechanical mice have displacement detection devices that can detect their own movement on the desktop, and control the target image on the screen to move accordingly according to the detected movement direction and distance information. The present gamepad has no displacement detection device, so it does not have displacement detection function. As a result, the gamepad cannot quickly and accurately control the movement of the target image on the screen. But the mouse needs to be used on a desktop, and it is far less comfortable than a gamepad that can be used in the air.

The present gamepad control the direction of the game character or the direction of the cursor by controlling the buttons or joysticks with the thumbs of each hand, respectively. In a first-person shooting game, front sight of gun are usually controlled by the right thumb, which controls the joystick of the gamepad. The right thumb's inflexible control of the joystick, as well as the joystick's insufficiently fast and accurate movement, all lead to inaccurate movement direction and distance of the front sight of, thus degrading the game experience. However, designers in the present gamepad space are still limited by the design way of buttons and joysticks.

### SUMMARY OF THE INVENTION

It is an object of the invention to provide a gamepad with a displacement detection device.

It is a further object of the invention to provide a gamepad with displacement detection function.

It is a further object of the invention to provide a gamepad, which can control the movement of an target image on the screen quickly and accurately.

It is a further object of the invention to provide a gamepad, which can control the movement of the target image on the screen in a horizontal or vertical direction quickly and accurately.

It is a further object of the invention to provide a method of using a game controller, which can control the movement of the target image on the screen quickly and accurately.

It is a further object of the invention to provide a gamepad with a displacement detection device, wherein the gamepad with a displacement detection device adopts an optical displacement detection device.

It is a further object of the invention to provide a gamepad with a displacement detection device, wherein the gamepad with a displacement detection device adopts a mechanical displacement detection device.

It is a further object of the invention to provide a gamepad with a displacement detection device, wherein the gamepad with a displacement detection device adopts an image displacement detection device.

It is a further object of the invention to provide a gamepad with a displacement detection device, wherein the gamepad with a displacement detection device adopts a magnetic displacement detection device.

It is a further object of the invention to provide a gamepad with a displacement detection device, wherein the gamepad with a displacement detection device controls a game cursor to move in an axial direction by operating an operating element along the axial direction.

It is a further object of the invention to provide a game controller with a displacement detection device, wherein the displacement detection device defines a detection channel and controls the axial displacement of the game cursor by detecting the axial displacement of the operating element by the axial movement of the operating element in the detection channel.

It is a further object of the invention to provide a game controller with a displacement detection device, wherein the displacement detection device defines a detection channel, and the displacement detection device comprises a detection module and an operating element, and the detecting module is capable of detecting the position of the operating element in the detection channel.

It is a further object of the invention to provide a game controller with a displacement detection device, wherein the displacement detection device provides a detection module for detecting the displacement of the operating element in the detection channel.

It is a further object of the invention to provide a game controller with a displacement detection device, wherein the detection module adopts an optical displacement detection module.

It is a further object of the invention to provide a game controller with a displacement detection device, wherein the detection module adopts a mechanical displacement detection module.

It is a further object of the invention to provide a game controller with a displacement detection device, wherein the detection module detects the displacement of the operating element in the detection channel by means of image recognition.

It is a further object of the invention to provide a game controller with a displacement detection device, wherein the the detection module detects the displacement of the operating element in the detection channel by means of magnetic detection.

It is a further object of the invention to provide a game controller with a displacement detection device, wherein the game controller with a displacement detection device further provides a reset button to cause the detection device to stop detecting the axial movement of the operating element.

It is a further object of the invention to provide a game controller with a displacement detection device, wherein the game controller with a displacement detection device provides an initialization module for coordinating the frequency of reporting data to a host computer connected to the game controller with a displacement detection device.

It is a further object of the invention to provide a game controller with a displacement detection device, wherein the initialization module provides a learning game for learning the user's using habits with the operating element.

It is a further object of the invention to provide a game controller with a displacement detection device, wherein the initialization module conFigs the game controller with a displacement detection device by reading a user configuration file.

It is a further object of the invention to provide a game controller with a displacement detection device, wherein the displacement detection device provides a letter module for transmitting displacement data to the game controller.

To realize the above object, the invention provides a gamepad, which comprises a housing, a displacement detection device, an input device arranged on the housing and a circuit board arranged in the housing, the input device is selected from one or two of a joystick module and a button module; the housing is provided with a displacement detection channel; the displacement detection device is arranged beside the displacement detection channel; The circuit board is provided with a control unit; The control unit is electrically connected with the input device and the displacement detecting device.

In one embodiment of the gamepad, the displacement detection channel is arranged laterally in the housing.

In one embodiment of the gamepad, the displacement detection device is an optical displacement detection module.

In one embodiment of the gamepad, the displacement detection device is a mechanical displacement detection module.

In one embodiment of the gamepad, the input device is a joystick module.

In one embodiment of the gamepad, the gamepad further comprise a positioning rod inserted into the displacement detection channel.

In one embodiment of the gamepad, a guiding wheel is a further provided in the housing, and the guiding wheel is arranged beside the displacement detection channel.

The invention a further provides a gamepad, which comprises a housing, a detection catheter connected with the housing, an input device arranged on the housing, and a circuit board arranged in the housing; The input device is selected from one or two of the joystick module and the button module; The detection catheter is provided with a displacement detection channel; The displacement detection channel is provided with a displacement detection device; The circuit board is provided with a control unit; The control unit is electrically connected with the input device and the displacement detecting device.

In one embodiment of the gamepad, the input device is a button module.

In one embodiment of the gamepad, the input device is a joystick module.

In one embodiment of the gamepad, the displacement detection device is an optical displacement detection module.

In one embodiment of the gamepad, the displacement detection device is a mechanical displacement detection module.

In one embodiment of the gamepad, the gamepad further comprise a positioning rod inserted into the displacement detection channel.

The invention further provides a gamepad, which comprises a housing, a joystick module, a circuit board, a control unit arranged on the circuit board, and a detection catheter. The detection catheter is provided with a displacement detection channel in itself; The displacement detection channel is provided with an optical displacement detection module beside itself; The control unit is electrically connected with the optical displacement detection module; The detection catheter is connected with the front end of the housing; The detection catheter is placed horizontally.

The invention further provides a gamepad, which comprises a housing, a detection catheter connected with the housing, an input device arranged on the housing, and a circuit board arranged in the housing; The input device is selected from one or two of the joystick module and the button module; The circuit board is provided with a control unit; The detection catheter is provided with a displacement detection channel in itself; The displacement detection channel is provided with a displacement detection device beside itself; The control unit is electrically connected with the input device and the displacement detecting device; The connection mode between the detection catheter and the housing is a movable connection mode.

In one embodiment of the gamepad, the detection catheter is arranged transversely, and the connection mode between the detection catheter and the housing is a rotational connection mode.

In one embodiment of the gamepad, the input device is a button module, and the connection mode between the detection catheter and the housing is a universal connection mode.

In one embodiment of the gamepad of the invention, a guiding wheel is also arranged on the detection catheter, and the guiding wheel is arranged beside the displacement detection channel.

The invention further provides a gamepad, which comprises a housing, a joystick module, a circuit board and a control unit arranged on the circuit board, further comprise a positioning rod and detection catheter; the positioning rod is arranged horizontally, one end of which is connected with the front end of the housing; the detection catheter is arranged on the positioning rod and can move along the positioning rod; an optical displacement detection module is arranged on the detection catheter; the control unit is connected with the optical displacement detection module.

In one embodiment of the gamepad, the input device is a joystick module.

In one embodiment of the gamepad, the displacement detection device is an optical displacement detection module.

In one embodiment of the gamepad, the displacement detection device is a mechanical displacement detection module.

In one embodiment of the gamepad, a rotating connection is formed between the positioning rod and the housing.

The invention further provides a method of using a game controller, comprising: obtaining a control signal by an input device; obtaining a displacement information by a displacement detection device. sending out displacement signal according to displacement information by a control unit; sending out the control signal by the control unit.

The invention further provides a method for using a gamepad whose displacement detection device is an optical displacement detection module, comprising: the control unit output of the mobile signal in only one axis of the moving data.

The gamepad of invention can control various computer devices, comprising: but not limited to PC, TV game console, smart phone, tablet computer and handheld game consol.

The gamepad of the invention provides a displacement detection channel and a displacement detection device on the handle, so that the gamepad also has the displacement detection function when used in the air. At the same time, it can output the displacement signal according to the detected displacement, and has the performance of rapidly and accurately controlling the movement of the target image on the screen. At the same time, it retains the feature that the gamepad can be used in the air, and integrates the advantages of the gamepad and mouse, two kinds of video game controllers in the existing technology, increasing the fun of the game.

To realize the above object, the invention provides a game controller, comprising:
a handle part comprising:
a housing;
at least one input device arranged at the surface of the housing; and
a control module arranged inside the housing and connected to the input device communicatively; and
a displacement detection device connected to the control module communicatively, wherein the displacement detection device further defines a detection channel, and comprises a detection module and an operating element, wherein the detection module is arranged on one side of the detection channel and connected to the control module communicatively, wherein the operating element is moved axially by the detection channel to generate at least one displacement data, which is transmitted to the control module for the control module to provide displacement control based on at least one the displacement data.

According to an embodiment of the invention, wherein the detection module is arranged in the housing, wherein the detection channel is formed in the housing, and the detection channel runs through the opposite sides of the housing for the operating element to move axially in the detection channel.

According to an embodiment of the invention, wherein the housing further comprises an input part and a holding part, wherein the input part is arranged on the top part of the holding part, wherein the detection module and the detection channel are arranged at the input part.

According to an embodiment of the invention, wherein the displacement detection device is arranged outside the housing, wherein the displacement detection device further comprises a detection frame, and the detection channel is defined in the detection fram, the detection channel runs through the detection frame so that the operating element passes through the detection frame and move axially, wherein the detection module is arranged on one side of the detection frame for detecting the displacement of the operating element in the detection frame for axial ground movement.

According to an embodiment of the invention, wherein a movable connection is formed between the detection frame and the housing.

According to an embodiment of the invention, wherein the detection frame is a detection catheter.

According to an embodiment of the invention, wherein the detection frame is set as a cuboid, wherein the detection frame further comprises two channel opening frame, and the two channel opening frame are located at two ends of the detection channel for defining two channel opening of the detection channel respectively, a guiding wheel is respectively installed on the bottom side of the two channel opening frame to make the operating element move axially on the guiding wheel to reduce the friction force when the operating element moves in the detection frame.

According to an embodiment of the invention, the detection frame is also provided with a guiding wheel, which is located next to the detection channel.

According to an embodiment of the invention, the detection catheter is provided with a guiding wheel, and the guiding wheel is arranged beside the detection channel.

According to an embodiment of the invention, wherein the detection module is selected from either optical displacement detection module or mechanical displacement detection module.

According to an embodiment of the invention, wherein the detection module further comprises a camera and a light emitting module, wherein the operating element is provided with a set of positioning marks.

According to an embodiment of the invention, wherein the detection module further comprises a camera and a light emitting module, wherein the operating element is provided with a set of positioning marks, wherein the light emitting module provides lighting so that the camera module can capture the positioning marks located on the operating element and form an image; the camera module transmits the image to the control module, and the control module obtains the displacement data of the movement of the cursor by image processing of the image.

According to an embodiment of the invention, wherein the detection module further comprises a camera module and a light emitting module, wherein the operating element is provided with a set of positioning markers, each of the two adjacent the positioning markers have the equal interval, the set of positioning markers are different, wherein the light emitting module provides lighting so that the camera module can capture the positioning mark located on the operating element, the camera module transmits the positioning mark when the operating element starts to move and the positioning mark when it stops moving to the control module respectively, the camera module transmits the positioning mark when the operating element starts to move and the positioning mark when it stops moving to the control module respectively, the control module according to the photo of the positioning mark and shooting time when the operating element starts to move, and the photo of the positioning mark and shooting time when it stops moving, and the displacement of the operating element obtained according to the interval between two adjacent the positioning marks.

According to an embodiment of the invention, wherein the detection module further comprises a magnetic induction module, and the operating element is provided with a magnetic device, wherein the magnetic device is limited to move axially in the detection channel, wherein the magnetic induction module transmits the direction and magnetic force value to the control module, and the control module obtains the position of the operating element according to the detected magnetic field direction and magnetic force value.

According to an embodiment of the invention, wherein the operating element further comprises a positioning part and an operation part, the positioning part is adjacent to the operation part, wherein the positioning part moves axially in the detection channel, wherein the operation part is for helding by the user to operate the positioning part axially.

According to an embodiment of the invention, wherein the input device further comprises a reset button, which is connected to the control device communicatively, wherein the control device controls the detection module to pause detecting the displacement of the operating element in the detection channel when the reset button is pressed.

According to an embodiment of the invention, wherein the control module further comprises a processing module and a communication module, wherein the processing module is respectively connected to the communication module, the detection module and the input device communicatively, and the processing module processes the data acquired by the detection module into displacement data, the processing module processes the date obtained by the input device into operational data, wherein the communication module is connected with a host computer to transmit the displacement data and the operating data to the computer.

According to an embodiment of the invention, wherein the control module further comprises an initialization module, and the initialization module is connected to the communication module communicatively and obtains the performance parameters of the host computer by the initialization module to coordinate the frequency of the displacement data transmitted to the host computer according to the performance parameters of the host computer so that computer host computer process the displacement data in real time, thereby avoiding frame loss.

According to an embodiment of the invention, wherein the initialization module coordinates the sampling frequency of the detection module for the operating element according to the performance parameters of the host computer.

According to an embodiment of the invention, wherein the control module further comprises a user configuration module, the user configuration module connected to the initialization module and the communication module communicatively, wherein the user configuration module stores a practice game, wherein the initialization module sends the practice game to the host computer to run through the communication module, the practice game is sent to the host computer to run, wherein, in the process of running the practice game, the initialization module generates a user configuration file to optimize the control of the displacement detection device to the game according to obtained performance parameters of the host computer, and obtained resolution of a display screen connected to the host computer, the sampling rate of the detection module to the operating element, and the speed of learning the user to move the operating element in the process of running the practice game.

To realize the above object or other objects, the invention provides a displacement detection device for a game controller, comprising:
a detection frame installed in the connecting device, wherein the detection frame defines a detection channel;
a detection module arranged at one side of the detection frame;
a operating element through the detection channel, wherein the detection module in the detection channel detects the axial displacement of the operating element; and
a communication connecting to the one-handed game controller communicatively to transmit displacement data to the one-handed game controller.

According to an embodiment of the invention, wherein the displacement detection device further comprises a connecting device for mounting the displacement detection device at the controller removably.

According to an embodiment of the invention, wherein the detection module is selected from a optical displacement detection module and a mechanical displacement detection module.

According to an embodiment of the invention, wherein the detection module further comprises a camera module and a light emitting module, wherein the operating element is provided with a set of positioning markers, each of the two adjacent the positioning markers have the equal interval, the set of positioning markers are different, wherein the light emitting module provides lighting so that the camera module can capture the positioning mark located on the operating element, the camera module transmits the positioning mark when the operating element starts to move and the positioning mark when it stops moving to the control module respectively, the camera module transmits the positioning mark when the operating element starts to move and the positioning mark when it stops moving to the control module respectively, the control module according to the photo of the positioning mark and shooting time when the operating element starts to move, and the photo of the positioning mark and shooting time when it stops moving, and the displacement of the operating element obtained according to the interval between two adjacent the positioning marks.

According to an embodiment of the invention, wherein the displacement detection module further comprises a magnetic induction module, and the operating element is provided with a magnetic device, wherein the magnetic device is limited to move axially in the detection channel, wherein the magnetic induction module transmits the direction and magnetic force value to the control module, and the control module obtains the displacement of the operating element according to the detected magnetic field direction and magnetic force value.

According to an embodiment of the invention, wherein the detection frame is set as a cuboid, wherein the detection frame further comprises two channel opening frame, and the two channel opening frame are located at two ends of the detection channel for defining two channel opening of the detection channel respectively, a guiding wheel is respectively installed on the bottom side of the two channel opening frame to make the operating element move axially on the guiding wheel to reduce the friction force when the operating element moves in the detection frame.

According to an embodiment of the invention, wherein the connection device is a universal connection device.

To realize the above object or other objects, the invention provides a game controller, comprising:
a housing, an input device arranged on the surface of the housing, a control module arranged inside the housing, a detection frame connected with the housing, a detection channel formed inside the detection frame, there is provided with a detection module beside the detection channel, there is provided with an operating element inside the detection channel;
The input device is connected to the control module communicatively, and the detection module is connected to the control module;
According to an embodiment of the invention, the detection frame is a detection catheter;
According to an embodiment of the invention, a movable connection is formed between the detection frame and the housing;
According to an embodiment of the invention, the detection module is selected from either an optical displacement detection module or a mechanical displacement detection module;
According to an embodiment of the invention, the detection module further comprises a camera and a light emitting module, and the operating element is provided with a set of positioning marks.

According to an embodiment of the invention, the detection module further comprises a magnetic induction module and the operating element is provided with a magnetic device.

According to an embodiment of the invention, the housing further comprises an input part and a holding part, and the detection frame is connected with the input part. To realize the above purpose, the invention provides a displacement detection device for a game controller, wherein the game controller comprises a housing, at least one input device and a control unit, the control unit is arranged inside the housing, and the input device is arranged on the surface of the housing, wherein the housing defines a detection channel, wherein the detection channel passes through the housing, wherein the displacement detection device further comprises a detection module and an operating element, wherein the detection module is arranged on one side of the operating element, and the operating element moves axially in the detection channel.

### BRIEF DESCRIPTION OF THE DRAWINGS

FIG. 1 shows a gamepad in prior art.

FIG. 2 shows a gamepad whose a displacement detection channel set horizontally.

FIG. 3 is a side view of the gamepad whose the displacement detection channel set horizontally.

FIG. 4 shows a gamepad comprising a positioning rod.

FIG. 5 shows the method of using the gamepad.

FIG. 6 shows a gamepad whose the displacement detection channel set longitudinally.

FIG. 7 is a side view of the gamepad whose the displacement detection channel set longitudinally.

FIG. 8 shows a gamepad comprising a positioning rod.

FIG. 9 shows the position relationship between the mechanical displacement detection module and the positioning rod.

FIG. 10 shows the installation mode of mechanical displacement detection module when the displacement detection channel is set horizontally.

FIG. 11 shows the installation method of the mechanical displacement detection module when the displacement detection channel is set longitudinally.

FIG. 12 shows a gamepad whose detection catheter placed horizontally.

FIG. 13 is a side view of a gamepad whose detection catheter placed horizontally.

FIG. 14 shows the rotation pattern of the detection catheter placed horizontally.

FIG. 15 shows a gamepad with the positioning rod.

FIG. 16 shows a gamepad whose connection method between the detection catheter and the housing is a rotational connection mode.

FIG. 17 is the top view of the gamepad shown in FIG. 16.

FIG. 18 shows the installation method and position of the optical displacement detection module in the detection catheter.

FIG. 19 shows the installation method and position of the mechanical displacement detection module in the detection catheter.

FIG. 20 shows a gamepad whose housing is connected to the positioning rod.

FIG. 21 shows a schematic diagram of a game controller with a displacement detection device for another preferred embodiment of this application.

FIG. 22 shows a schematic diagram of a displacement detection device for another preferred embodiment of this application.

FIG. 23 shows a schematic diagram of a game controller with a displacement detection device for another preferred embodiment of this application.

FIG. 24 shows the structural block diagram of a game controller with a displacement detection device for another preferred embodiment of this application.

FIG. 25 shows a schematic diagram of another displacement detection device for another preferred embodiment of this application. (magnetic detection device)

FIG. 26 to FIG. 27 are schematic diagram of the detection process of another preferred implementation displacement detection device in this application.

FIG. 28 shows a schematic diagram of another displacement detection device for another preferred embodiment of this application.

FIG. 29 shows a schematic diagram of another displacement detection device for another preferred embodiment of this application.

FIG. 30 shows a diagram of another operating element from FIG. 28.

FIG. 31 shows a game interface for another preferred embodiment of this application.

FIG. 32A to FIG. 32D is a schematic diagram of the operation game for another preferred embodiment of this application.

FIG. 33 shows a schematic diagram of a game controller with a displacement detection device for another preferred embodiment of this application.

FIG. 34 shows a schematic diagram of a game controller with a displacement detection device for another preferred embodiment of this application.

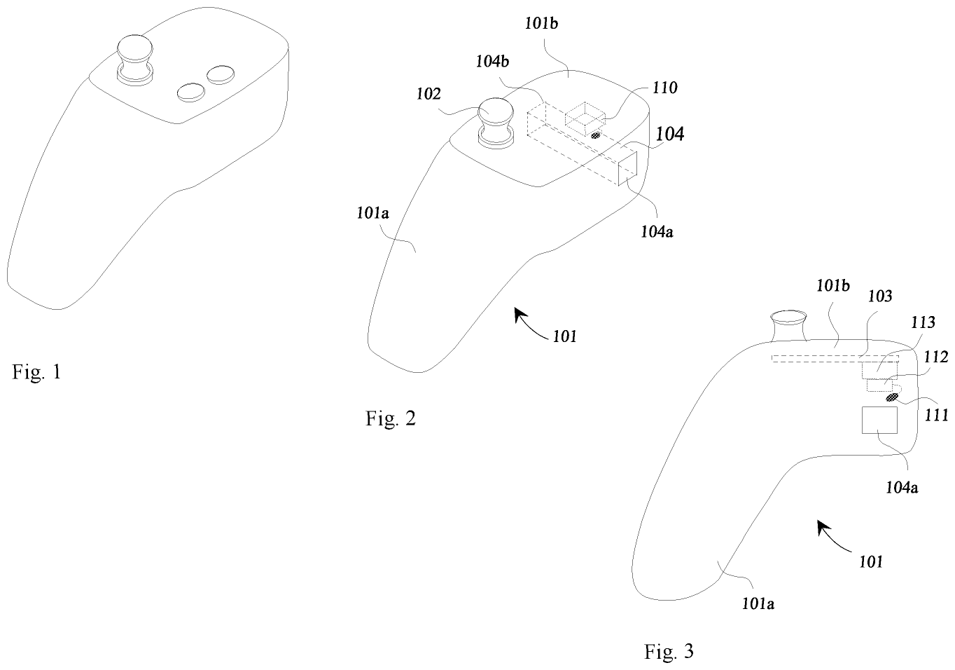

### DETAILED DESCRIPTION OF THE PREFERRED EMBODIMENT

In the following, the invention will be further explained by specific embodiments combined with the attached drawings. However, the embodiments are only examples of the optional embodiments of the invention, and the features disclosed in the embodiments are only used to illustrate and elaborate the technical scheme of the invention, and are not used to limit the scope of protection of the invention.

A person skilled in the field shall understand that, in the disclosure of the invention, the azimuth or position relationship indicated by the terms “vertical”, “horizontal”, “up”, “down”, “front”, “back”, “left”, “right”, “vertical”, “horizontal”, “top”, “bottom”, “inside”, “outside”, etc., is based on the azimuth or position relationship shown in the attached drawing. They are intended only to facilitate the description of the invention and to simplify the description, and are not intended to indicate or imply that the device or element referred to must have a particular orientation, be constructed and operated in a particular orientation, and therefore such terms shall not be construed as a limitation of the Invention.

### The First Embodiment

The embodiment provides a game controller, comprising a housing 101, a displacement detection device 110, a circuit board 103 arranged in the housing 101, and an input device arranged on the housing 101; A control unit is arranged at the circuit board 103; A displacement detection channel 104 is arranged in the housing 101; The displacement detection device 110 is arranged on the side of the displacement detection channel 104; The input device is selected from one or two of a joystick module and a button module; The input device for the user to input control signals (the signals which joystick module and button module generated are called control signals); The displacement detection device 110 generates displacement information; The control unit generates a displacement signal according to the displacement information, and sends the control signal and displacement signal to the host computer connected with it. The control unit can be single chip microcomputer. Preferably, STM32F407 chip is selected as the chip of the control unit in this embodiment.

The game controller is used to control the host computer, which is a computer device. The host computer is used to run video game software and display the game content on the screen be driven. The host computer controls the displayed content on the screen according to the received control signal and displacement signal.

In one embodiment of the gamepad of the present embodiment, the displacement detection channel 104 is arranged horizontally on the housing 101. As shown in FIG. 2, whole housing 101 has a shape suitable for holding with one hand, roughly divided into a holding part 101a located in its rear and a control part 101b located in its front. The input device in this embodiment is a joystick module, and the joystick module is arranged on the housing 101, comprising the joystick 102 on the surface of the housing 101 and the part in the housing 101, the part in the housing 101 is electrically connected with the circuit board 103, and the STM32F407 chip of the control unit is arranged on the circuit board 103.

It can also be seen from FIG. 2 that there is a displacement detection channel 104 in housing 101, which is a rectangular space transversally through housing 101. There is a square right side opening 104a on a side of the control part 101b, and a square left side opening 104b on corresponding side of the control part 101b. A displacement detection device 110 is arranged inside control part 101b, which is located next to displacement detection channel 104. Preferably, displacement detection device 110 is optical displacement detection module, as shown in FIG. 3. The optical displacement detection module is located inside the housing 101, comprising light-emitting diode 111, optical lens 112 and optical engine 113. The light-emitting diode 111 and optical lens 112 are set near the displacement detection channel 104. The optical engine 113 is arranged on the circuit board 103 inside the housing 101 and is electrically connected to the control unit. In the drawings, the dashed lines represent the parts in the housing 101.

Optical Engine 113 comprises image sensor and DSP (digital signal processor). Preferred, the optical engine 113 is Agilent's A0214 optical engine.

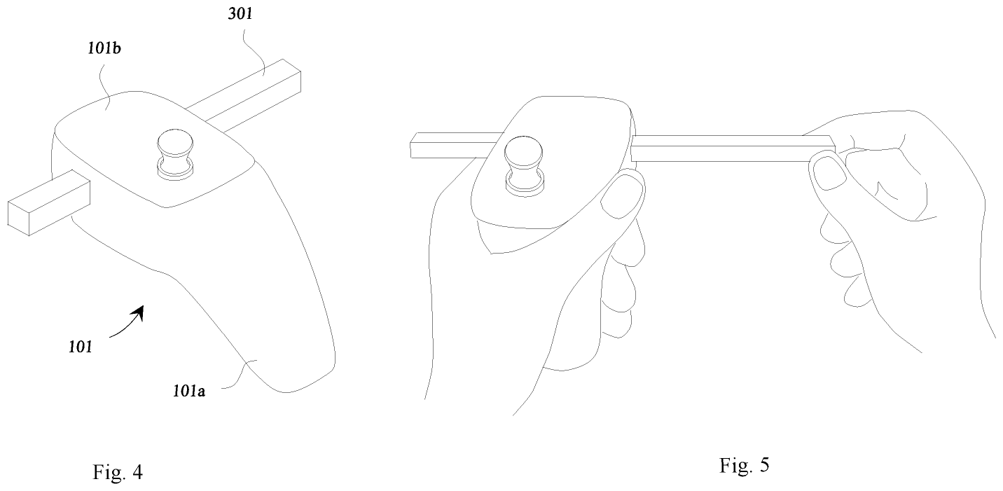

In the game controller of this embodiment, the user can not only generate control signals by flipping the joystick 102, but also generate displacement signals by the optical displacement detection module. It is necessary to place a positioning rod in the displacement detection channel 104 to generate displacement signal. As shown in FIG. 4, there is a positioning rod 301 inserted horizontally on the control part 101b. The positioning rod 301 is a rectangular long rod. The cross section of the positioning rod 301 is square and the size fits the left and right square openings on the housing 101. The positioning rod 301 can move easily but not too loose in the displacement detection channel 104. For example, the dowel rod has a square cross section with each side of the square measuring 8 mm in length, while the two square openings on housing 101 have each side measuring 8.5 mm in length.

The following is to control the cursor movement on the display screen driven by a PC as an example to illustrate the using method of the gamepad in this embodiment. The user holds the gamepad with his left hand and grasps the right end of the positioning rod 301 with his right hand to control the movement of the positioning rod 301 in the displacement detection channel 104. At this time, the light emitted by the hight-emitting diode 111 illuminates the surface of the positioning rod 301 and enters the optical engine 113 through the optical lens 112, and forms a continuous digital image on the image sensor in the optical engine 113. The DSP processes the digital image. When the positioning rod 301 moves, the two adjacent digital images will change, and DSP can obtain the movement information (comprising the direction and distance of movement) of positioning rod 301 according to the changes. After the movement information is sent to the control unit, the control unit sends a displacement signal to the host (PC) according to the movement information, and the PC controls the cursor on the screen to move accordingly according to the displacement signal. FIG. 5 shows the using method of gamepad in this embodiment. The player can also shake the handle with the right hand and control the positioning rod 301 with the left hand to operate the game controller of this embodiment.

The existing optical mouse also uses displacement detection modules comprising light-emitting diodes, optical lenses and optical engines to detect its movement on the desktop. The detected movement information is sent to the control unit in the optical mouse, and the control unit sends the displacement signal according to the movement information. When the optical mouse of the prior art moves on a surface, its optical displacement detection module can detect the horizontal and longitudinal displacement of the mouse, and the control chip converts the horizontal and longitudinal displacement into the X axis and Y axis moving data respectively and sends them to the host, in other words, the displacement signal comprising the X axis and Y axis moving data sent by the control chip to the host computer. According to the displacement signal, the host computer controls the image on the screen for corresponding movement. For example, if the mouse moves up a short distance to the right, the control chip outputs X+10 and Y+10. The cursor on the screen moves 10 pixels to the right and 10 pixels up. The mouse moves down a short distance to the left, the control chip outputs X−10, Y−10, and the cursor on the screen moves 10 pixels to the left and 10 pixels down.

The same technique is used for the gamepad in this embodiment and the optical mouse in prior art to obtain the displacement information from the optical displacement detection module and to generate the displacement signal from the control unit based on the displacement information. The difference is that the what is detected is movement of the positioning rod in the displacement detection channel, in other words, the movement of only one line can be detected. During installation, ensure that the comprised Angle between the optical displacement detection module and the displacement detection channel is a right Angle (as shown in FIG. 2), and the control unit will only output the movement data of one axis. For example, positioning rod 301 moves a short distance to the right, the control unit outputs X+10, and the cursor on the screen moves 10 pixels to the right; The positioning rod 301 moves a short distance to the left, the control unit outputs X−10, and the cursor on the screen moves 10 pixels to the left. By controlling the direction and distance of the positioning rod, the user can quickly and accurately control the movement of the cursor on the X axis.

The prior art optical mouse, when we hold it diagonally, and move it horizontally or vertically across the table, will find that the cursor on the screen moves diagonally because the optical displacement detection module is not at a right Angle to the line it is moving. For the gamepad in this embodiment, if the comprised Angle between the optical displacement detection module and the displacement detection channel is not a right Angle during installation, the displacement signal sent by the control unit will comprise the movement data of both X and Y axes when the positioning rod moves. Cause the cursor on the screen is also inclined to move, forming a control deviation. To solve this problem, this embodiment also provides a way of using a gamepad in which the control unit is set to output only one axis of movement data at any one time. For example, according to the displacement information provided by the optical engine, the displacement signal of the control unit only outputs X+10 when it should output X+10 and Y+2. The beneficial effect of this method is that even if the Angle of the optical displacement detection module is slightly deviated during installation, there will be no control deviation during use. The using method is applicable to the all game controller whose displacement detection devices in the invention are optical displacement detection modules.

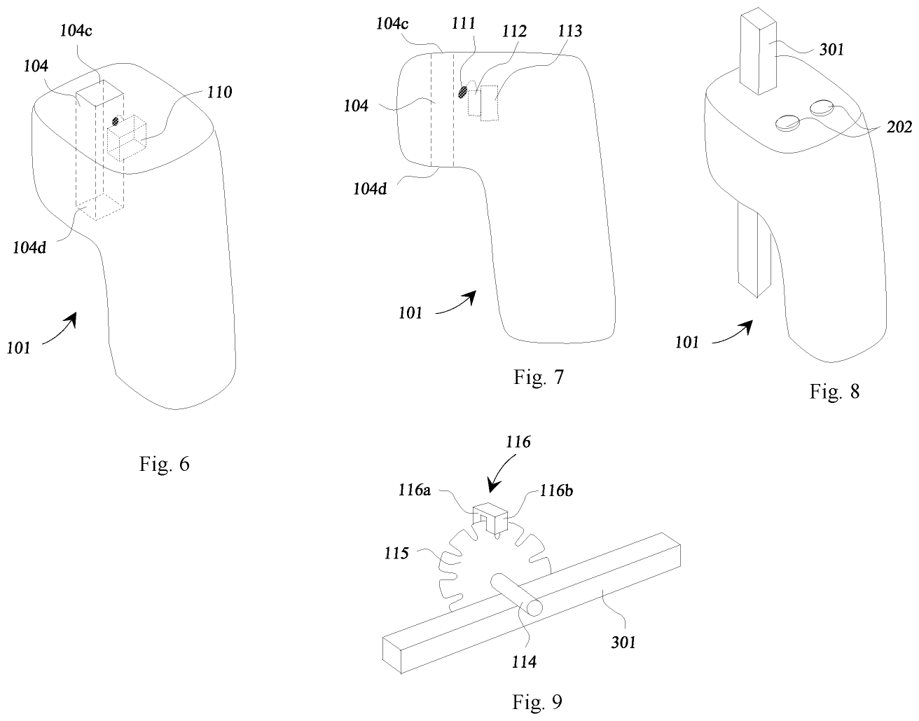

In one embodiment of the gamepad in this embodiment the displacement detection channel is arranged longitudinally in the housing 101. As shown in FIG. 6, displacement detection channel 104 is set longitudinally in housing 101. The displacement detection channel 104 has a square upper side opening 104c on the upper surface of housing 101 and a square lower side opening 104d on the lower surface. The displacement detection device 110 is located next to the displacement detection channel 104.

When the displacement detection device 110 is an optical displacement detection module, its installation mode is shown in FIG. 7. high-emitting diode 111, optical lens 112 and optical engine 113 are arranged next to displacement detection channel 104.

The game controller whose displacement detection channel 104 setting longitudinally also need to use the positioning rod during the period of use. As shown in FIG. 8, the positioning rod 301 is longitudinally inserted into the housing 101, exposing a section above and below the housing 101, and the middle part is located in the displacement detection channel 104. When the positioning rod 301 moves longitudinally in the displacement detection channel 104, the optical displacement detection module can obtain displacement information according to the direction and distance of movement. In this embodiment, the input device is a button module, and the button module is arranged on the housing 101, comprising a button 202 on the surface of the housing 101 and a part in the housing 101. The control information which the user generated by the button module is sent to the connected host computer by the control unit to realize the corresponding button control function.

By holding the housing 101 with one hand, and grabs the positioning rod 301 and moves it up or down with the other hand, so that the displacement signal is generated to control the movement of the target image on the screen. When the displacement detection module is installed, adjust the orientation so that when the positioning rod 301 moves up and down, the control unit outputs the movement value on the Y axis. For example, if the dowel rod moves up a short distance, the control unit outputs Y+10; if the positioning rod 301 moves down a short distance, the control unit outputs Y−10. The user can use the positioning rod 301 to control the movement of the cursor on the Y axis of the screen.

In one mode of implementation of the gamepad in this embodiment, the displacement detection device 110 is a mechanical displacement detection module. The mechanical displacement detection module comprises roller, grating wheel and grating signal sensor. In the prior art, the mechanical displacement detection module is used in the mechanical mouse to detect the movement of the mechanical mouse on the desktop. When the mechanical mouse moves on the desktop, a ball located at the bottom of the mouse rolls, which turns a roller that is close to the wheel. The roller drives the connected grating wheel to rotate, and the grating signal sensor detects the rotation direction and speed of the grating wheel, and sends the displacement information to the control unit of the mechanical mouse. The control unit sends the displacement signal to the connected host computer according to the displacement information, and the host computer controls the cursor on the display screen to move accordingly.

The mechanical mouse in the prior art, whose two mechanical displacement detection modules are used to detect the movement information of the mouse on the X axis and the Y axis respectively. In this embodiment, only one mechanical displacement detection module is used for the gamepad. The specific installation mode is shown in FIG. 9. Roller 114 is installed on the side of the displacement detection channel 104. Roller 114 passes through the center of grating wheel 115 and is fixedly connected at the center; The grating signal sensor 116 is arranged next to the grating wheel 115. After positioning rod 301 is inserted into the displacement detection channel 104, roller 114 and positioning rod 301 are next to each other. When the positioning rod 301 moves in the displacement detection channel 104, it drives roller 114 to rotate, and the grating wheel 115 connected with roller 114 also rotates synchronously. The grating signal sensor 116 comprises an infrared transmitting tube 116a and an infrared receiving module 116b, which are respectively located on both sides of the grating wheel 115. The infrared receiving module 116b is used to receive infrared light emitted by the infrared transmitting tube 116a. When the grating wheel 115 rotates, the teeth on the edge of the grating wheel 115 periodically block the infrared receiving module 116b to receive infrared light, thus generating an electrical pulse signal in the infrared receiving module 116b. The displacement information of the movement of the positioning rod 301 is recorded in the electrical pulse signal. The control unit sends a displacement signal to the connected host computer according to the electrical pulse signal.

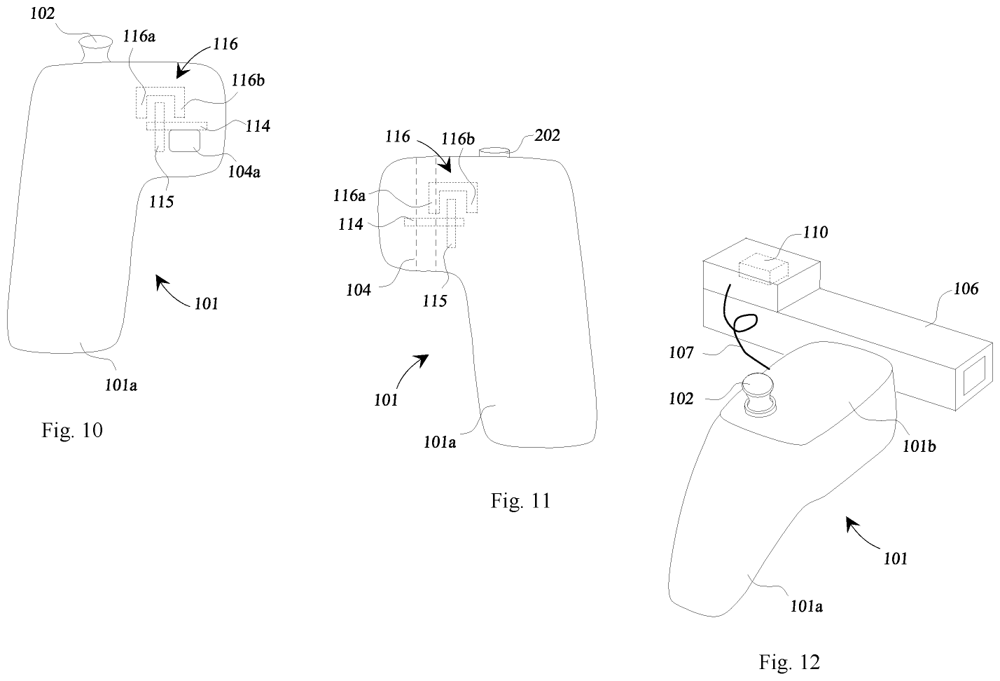

When the displacement detection channel 104 is set horizontally, the installation position of the mechanical displacement detection module in the housing 101 is shown in FIG. 10. Roller 114 is close to the displacement detection channel 104 and maintains an Angle of 90 degrees with the displacement detection channel 104. The ends of roller 114 are fixed with brackets so that the roller 114 can only rotate but not move. The positioning rod 301 is inserted into the displacement detection channel 104 and is just close to roller 114. When the positioning rod 301 is moved in the displacement detection channel 104, the roller 114 can be rotated and the displacement signal can be generated by the control unit. Preferably, the logic of the displacement signal generated by the control unit is: when the positioning rod 301 moves to the right, the control unit outputs the displacement signal of X+; when the positioning rod 301 moves to the left, the control unit outputs the displacement signal of X−. The user can control the horizontal movement of the target image on the screen by operating the positioning rod 301 to move around.

When the displacement detection channel 104 is set vertically, the installation position of the mechanical displacement detection module in housing 101 is shown in FIG. 11. Roller 114 is located next to displacement detection channel 104 set longitudinally, and the Angle between it and displacement detection channel 104 is 90 degrees. The positioning rod 301 is inserted into the displacement detection channel and is close to the roller 114. Moving the positioning rod 301 up and down can make the roller 114 roll, so that the control unit generates displacement signal. Preferably, the logic of the displacement signal generated by the control unit is that the positioning rod 301 moves up, the control unit outputs the displacement signal of Y+, and when the positioning rod 301 moves down, the control unit outputs the displacement signal of Y−. The user can control the longitudinal movement of the target image on the screen by operating the positioning rod 301 moving up and down.

The electrical pulse output displacement signal provided by the control unit according to the mechanical displacement module belongs to the prior art and will not be described in this specification.

### The Second Embodiment

This embodiment provides a gamepad, which differs from the gamepad in the first embodiment in that it further comprises a detection catheter connected to the housing 101. The displacement detection channel 104 and displacement detection module originally set in the housing 101 are set on the detection catheter instead.

In one embodiment of the gamepad in this embodiment, the detection catheter is set horizontally. As shown in FIG. 12, the detection catheter 106 is connected with the front end of the housing 101 (by bonding or bolted connection). The detection catheter 106 is a hollow rectangular tube with a square opening at each end, and a displacement detection channel 104 is formed in the middle of the two square openings. The displacement detection device 110 is arranged beside the displacement detection channel 104. After the positioning rod 301 is inserted, the movement within the detection catheter 106 can be detected by the displacement detection device 110. The displacement detection device 110 is electrically connected with the control unit in the housing 101 by the cable 107.

The length of the detection catheter 106 is much longer than the width of the housing 101. The beneficial effect of adding the detection catheter 106 to the gamepad is to increase the length of the displacement detection channel 104, thus increasing the stability of the positioning rod 301 after inserting the housing 101 and improving the control experience.

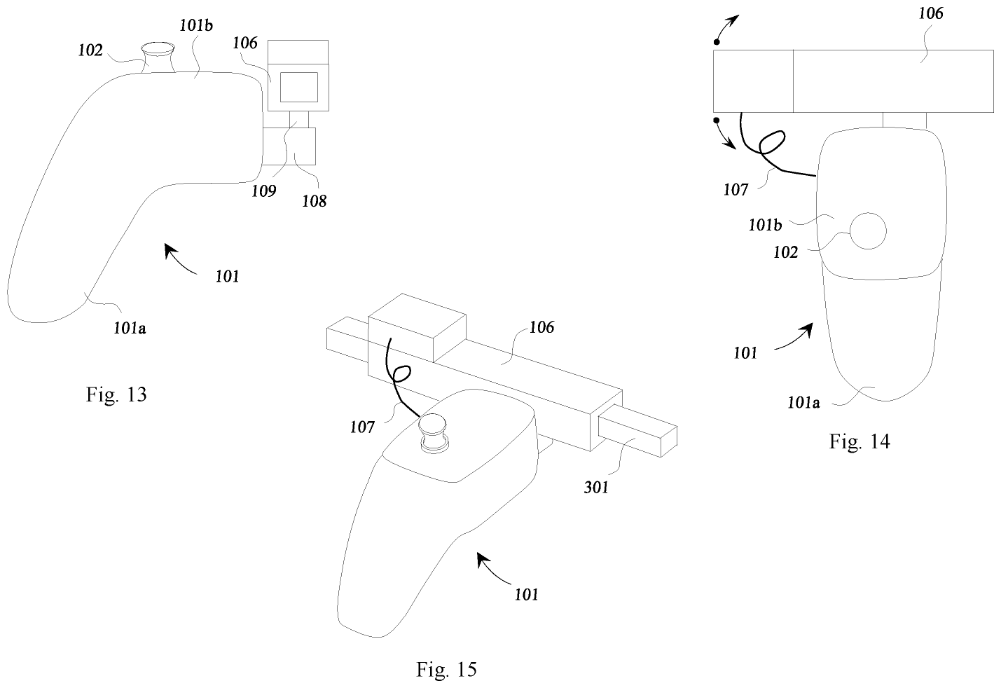

In one embodiment of the gamepad in this embodiment, the detection catheter 106 is set horizontally and capable of rotation, and its installation is shown in FIG. 13. There is a protrusion 108 at the front end of the housing 101, and a protrusion is provided with a mounting hole. The detection catheter 106 and the protruding part are connected by a connection shaft 109. One end of the connection shaft 109 is connected to the bottom of the detection catheter 106. The other end is inserted into the mounting hole and can be rotated in the mounting hole. The embodiment of the gamepad, whose detection catheter 106 can be rotated in a horizontal direction, as shown in FIG. 14.

There is a rotating connection between the catheter and the housing 101. The beneficial effect is that the posture is more comfortable and casual. When the displacement detection channel 104 is set in the housing 101 or the detection catheter 106 is fixed, the user's hands are in a relatively fixed position when using the handle, and the hand controlling the positioning rod 301 must be on the positive side of the housing 101. The detection catheter 106 can be rotated in a certain Angle, and the user's hand controlling the positioning rod 301 can move forward and backward within a certain range.

For a gamepad with a detection catheter 106, the displacement detection channel 104 on the detection catheter 106 is shown in FIG. 15 after the positioning rod 301 is inserted.

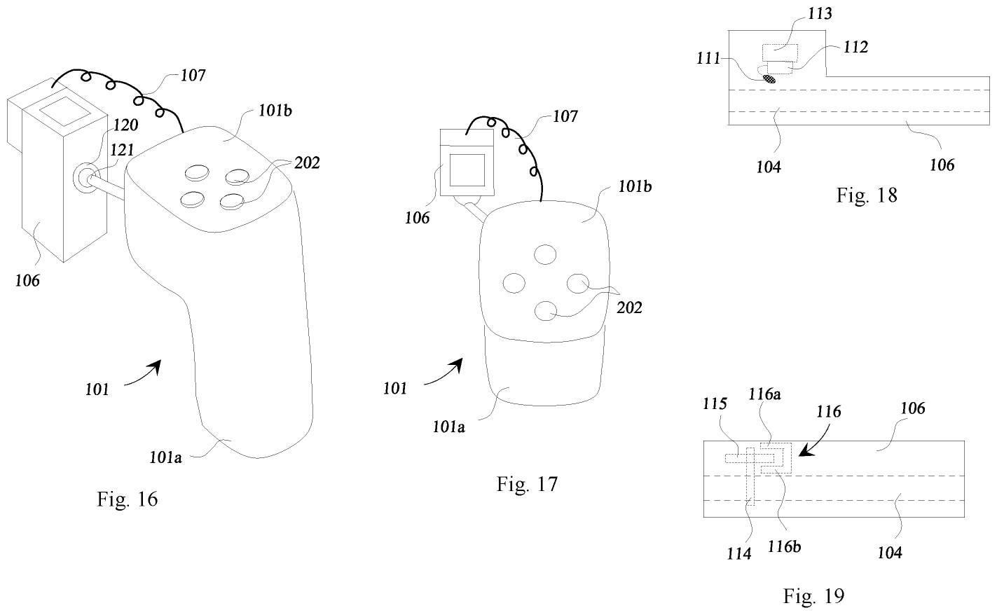

In one embodiment of the gamepad in the present embodiment, the detection catheter 106 and the housing are connected in a universal way, as shown in FIG. 16. The front end of the housing 101 and the middle position of the detection catheter 106 are connected by a universal connector. The universal connector comprises a ball and socket part 120 fixed in the middle of the detection catheter 106 and a ball head 121 fixed at the front end of the housing 101. The ball head 121 can be rotated in any direction in the socket part 120. Preferably, in this embodiment, the input device is the button module, as shown in FIG. 16, and button 202 is located on the top surface of housing 101.

FIG. 17 shows a top view of the handle in FIG. 16.

Displacement detection device 110 horizontal or vertical setting of the game controller, its use position is fixed. The gamepad with universal connection between the detection catheter 106 and the housing 101 can change the orientation of the detection catheter 106 in a wide range, and the control position is more casual, increasing the comfort.

In one embodiment of the gamepad in this embodiment, the displacement detection device 110 on the detection catheter 106 is an optical displacement detection module, and its installation is shown in FIG. 18. The light-emitting diode 111, optical lens 112 and optical engine 113 of the optical displacement module are arranged next to the displacement detection channel 104 in the detection catheter 116.

In one embodiment of the gamepad in this embodiment, the displacement detection device 110 on the detection catheter 106 is a mechanical displacement detection module, and its installation is shown in FIG. 19. Roller 114 is located next to displacement detection channel 104, and both ends are fixed on detection catheter 106. It can be rotated, but the position cannot be moved. After the positioning rod 301 is inserted, the movement in the displacement detection channel 104 can drive the roller 114 to rotate.

### The Third Embodiment

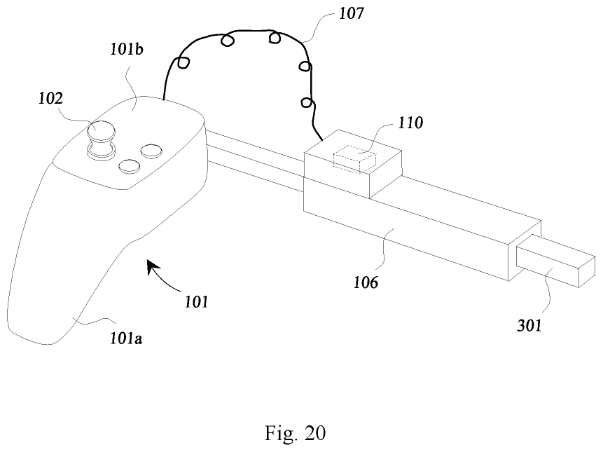

This embodiment provides a gamepad, as shown in FIG. 20, comprising a housing 101 suitable for holding with one hand, which is further divided into a holding part 101a and a control part 101b, on which a joystick 102 is attached. The right front end of the housing 101 is connected with a positioning rod 301, on which a detection catheter 106 is provided. A displacement detection device 110 is also provided on the detection catheter 106.

In one embodiment of the gamepad in this embodiment, the displacement detection device 110 is an optical displacement detection module.

In one embodiment of the gamepad in this embodiment, the displacement detection device 110 is a mechanical displacement detection module.

In one embodiment of the gamepad applied, the gamepad in the first embodiment is also provided with a guiding wheel. The guiding wheel is arranged in the housing 101, beside the displacement detection channel 104, and is arranged in pairs on the corresponding two sides. For example, when displacement detection channel 104 is set horizontally in the housing, a guiding wheel is provided on the upper and lower edges of displacement detection channel 104. The center of each guiding wheel is passed through a wheel shaft, which is fixed to the housing 101, the guiding wheel can be turned on the wheel shaft. After the positioning rod 301 is inserted into the displacement detection channel 104, its upper surface is just in contact with the guiding wheel on the upper edge; The lower surface is in contact with the guiding wheel on the lower edge. The positioning rod 301 in the displacement detection channel 104 can drive two guiding wheels to rotate simultaneously. Sliding friction becomes rolling friction, reducing friction, positioning rod movement more smooth, easy to operate. If displacement detection channel 104 is set lengthwise in housing 101, the two guiding wheels are located on the left and right sides of displacement detection channel 104.

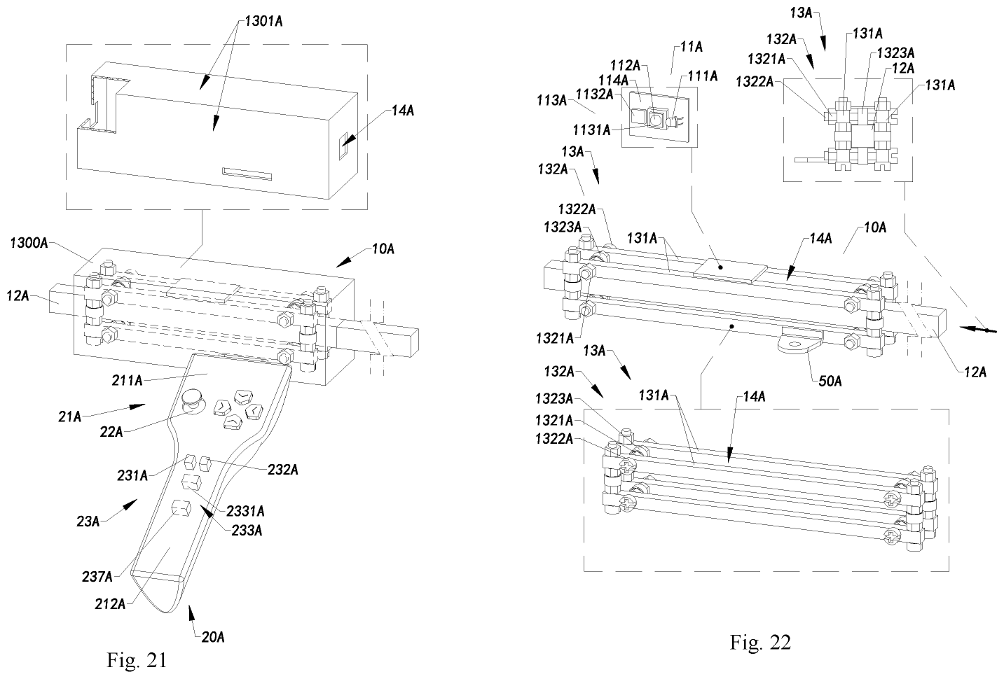

In one embodiment of the gamepad applied, a guiding wheel is also provided on the detection catheter 106 of the gamepad in the second embodiment and the third embodiment, and the guiding wheel is arranged beside the displacement detection channel 104. Preferably, set in pairs on both sides of the corresponding displacement detection channel 104. For example, when the detection catheter 106 is set horizontally, two on the upper edge and two on the lower edge of the displacement detection channel 104 are set. The center of each guide wheel passes through a wheel shaft, which is connected to the housing of the detection catheter 106, on which the guide wheel can be turned. After the positioning rod 301 is inserted into the displacement detection channel 104, its upper surface is in contact with the two guiding wheels on the upper edge. The lower surface is in contact with the two guiding wheels at the lower edge. When the positioning rod 301 moves in the displacement detection channel, it can drive the four guiding wheels to rotate simultaneously. Sliding friction becomes rolling friction, which reduces friction and makes it easier to use. FIG. 21 shows how to install the guiding wheel.

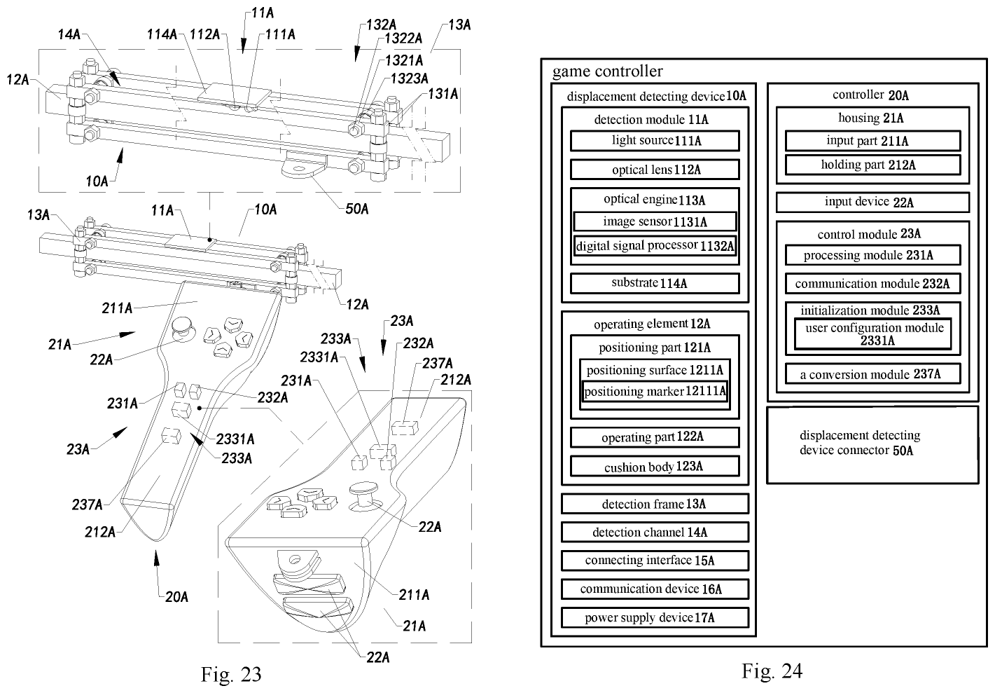

FIG. 21 to FIG. 24 illustrates the schematic diagram of a game controller with a displacement detection device, another preferred embodiment of this application, which is also a gamepad. This application for a game controller with a displacement detection device further comprises a displacement detection device 10A and a controller 20A. The displacement detection device 10A is connected with the controller 20A communicatively. The displacement detection device 10A sends the detected displacement data to the controller 20A. The controller 20A sends the displacement data obtained to a host computer 30. The housing of controller 20A is provided with a control module, and the displacement data detected by the displacement detection device 10A is sent to the host computer 30 by the control module. The host computer 30 processes the displacement data and converts it into the displacement data of the target controlled by the controller 20A. In a preferred embodiment of the invention, the controller 20A converts the received displacement data into the moving data of the controlled game object in a display device 40. The controller 20A sends the moving data of the converted game object to the host computer 30, and the host computer 30 executes the moving data of the display device 40 to make the game object move according to the moving data of the game object, so as to make the game object move the corresponding displacement in the display device 40.

As shown in FIG. 22, the displacement detection device 10A further comprises a detection module 11A and an operating element 12A. The operating element 12A moves within the detecting range of the detection module 11A. The detection module 11A detects the displacement of the operating element 12A moving within the detecting range. In other words, the operating element 12A is defined for the detection module 11A to move at the operating element 12A for a detection operation. Preferred, operating element 12A is the positioning rod.

The displacement detecting device 10A further comprises a detection catheter 1300A. The detection catheter 1300A defines a detection channel 14A. The detection catheter 1300A further comprises a detection frame 13A and four side wall 1301A. The four side wall 1301A is arranged on the side of the detection frame 13A to form the detection channel 14A in the middle of the detection frame 13A. The detection frame 13A defines a detection channel 14A to define the movement direction of the operating element 12A on the detection channel 14A. In other words, the operating element 12A moves along the detection channel 14A. The detection module 11A is arranged on one side of the detection frame 13A. In other words, the detection module 11A detects the movement of the operating element 12A in the detection frame 13A. The operating element 12A moves axially in the detection frame 13A. Preferably, the operating element 12A moves horizontally or vertically in the detection frame 13A.

The detection frame 13A further comprises at least two guiding element 131A and at least one fastener 132A. The guiding element 131A are fixed by the fastener 132A. The fastener 132A passes through the guiding element 131A respectively and fixes the two guiding element 131A at a preset position so that the two guiding element 131A remain parallel. The detection module 11A is arranged on the outer side of the two guiding element 131A. The operating element 12A moves along the guiding element 131A. Specifically, the operating element 12A moves along the guiding element 131A on the inner side of the guiding element 131A. The detection module 11A detects the displacement of the operating element 12A moving along the operating element 12A. The fastener 132A further comprises a group of limit elements 1321A and a connecting elements 1322A. The connecting element 1322A is respectively connected to the boot component 131A. The limit member 1321A is fixed at a preset position in the connection member 1322A. The guiding element 131A is limited to a fixed connection with the connecting element 1322A at the preset position so that two adjacent guiding elements 131A are connected parallel to the connector. The fastener 132A further comprises a guiding wheel 1323A, which is rotationally connected to the connector 1321A. The guiding wheel 1323A is fixed between the two limiting parts 1321A. The operating element 12A is guided to move in the direction that the guiding wheel 1323A rotates. The direction of rotation of the guiding wheel 1323A is consistent with the direction of movement along the guide piece 131A. In a preferred implementation of the invention, the connecting element 1322A is implemented as a connecting shaft. The limiting member 1321A is implemented as a nut. The guiding wheel 1323A is implemented as a bearing. The guiding wheel 1323A is arranged in the middle of the connecting piece 1322A. The two limits 1321A are fixed on the connecting element 1322A and the two limits 1321A are fixed on both sides of the guiding wheel 1323A. The two guides 131A are respectively fixed to the connecting element 1322A, and the guide 131A are respectively fixed to the outer side of the two limits 1322A. The other two limits 1322A are respectively fixed on the outer side of the two guides 131A. In such a manner, the two guiding elements 131A are kept parallel.

Further, one end of one of the guiding elements 131A is connected with the two connecting elements 1322A respectively. The two connecting elements 1322A are adjacent to one end of one of the guiding elements 131A. Preferably, the Angle between the two connecting elements 1322A is 90°. The other end of one of the guiding elements 131A is respectively connected with the other two connecting elements 1322A. The other two connecting elements 1322A are connected to the other end of one of the guiding elements 131A. Preferably, the Angle between the other two connecting elements 1322A is 90°. In this manner, the four guiding elements 131A are the long sides in the length direction of the cuboid respectively. In other words, preferably, the detection channel 14A is defined as a cuboid. The four guiding elements 131A are arranged at the position of four long sides of the cuboid by a plurality of connecting elements 1322A respectively. Preferably, the inlet and outlet of the detection channel 14A are defined as squares. The operating element 12A is restricted to an axial motion along the detection channel 14A.

The connection between the detection frame 13A and the detection catheter 1300A and the controller 20A can be movable, such as rotation or universal connection. It can also be a fixed connection, such as directly glued to the front end of the controller 20A.

In a preferred embodiment of the invention, the detection module 11A is implemented as an optical displacement detection module.

As shown in FIG. 22, the detection module 11A further comprises a light source 111A, an optical lens 112A and an optical engine 113A. The light source 111A is arranged on one side of the optical lens 112A. The optical engine 113A further comprises an image sensor 1131A and a digital signal processor (DSP) 1132A. When the detection module 11A is working, the operating element 12A moves within the detection channel 14A. The light source 111A is luminous. After the light emitted by the light source 111A irradiates to the surface of the operating element 12A, it enters the optical engine 113A through the optical lens 112A and forms a continuous digital image on the image sensor 1131A in the optical engine 113. The digital signal processor 1132A processes the digital image. When the operating element 12A moves, two adjacent digital images change. The digital signal processor 1132A obtains the movement information of the operating element 12A according to the change of two adjacent frames of digital images. The moving information comprises the moving direction and moving distance of the operating element 12A. After the movement information of the operating element 12A is sent to the controller 20A, the controller 20A sends the displacement information to the host computer 30A according to the movement information of the operating element 12A. The host computer 30 moves the cursor of the display screen according to the displacement information. Preferably, the light source 111A is a light-emitting diode. The detection module 11A further comprises a substrate 114A, and the light source 111A, the optical lens 112A and the optical engine 113A are installed on the substrate 114A. Preferably, the substrate 114A is provided with a corresponding circuit. The substrate 114A is mounted on the outer sides of the two boot pieces 131A. The light source 111A and the optical lens 112A face the interior of the detection frame 13A. In other words, the light source 111A and the optical lens 112A are disposed toward the detection channel 14A so that the light source 111A faces one of the surfaces of the operating element 12A.

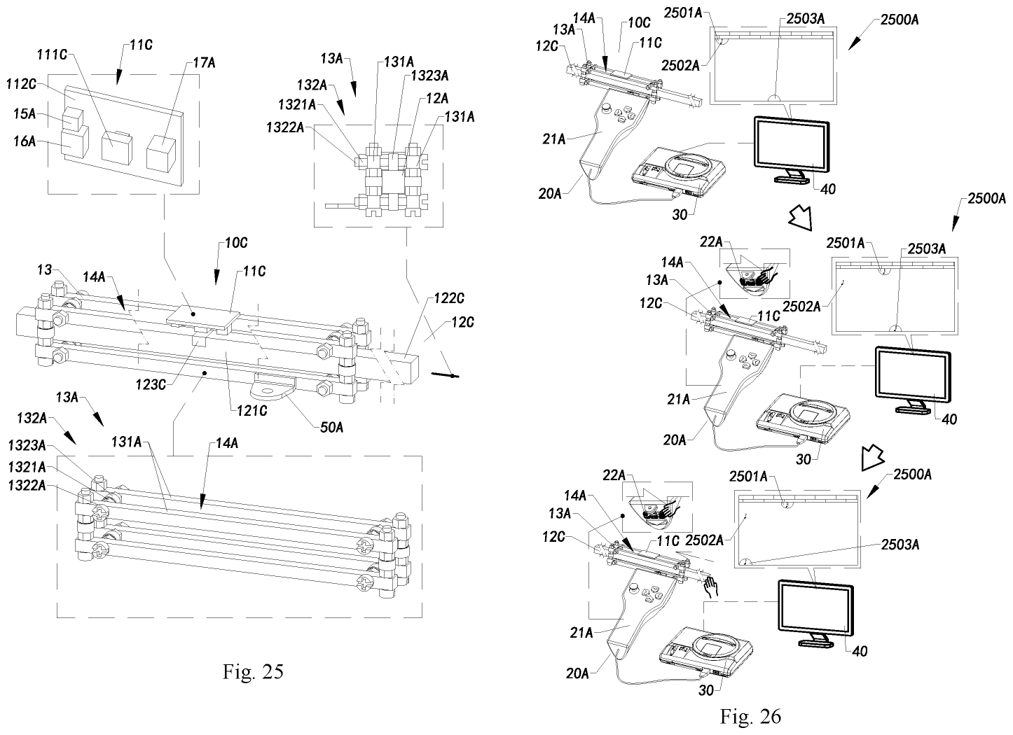

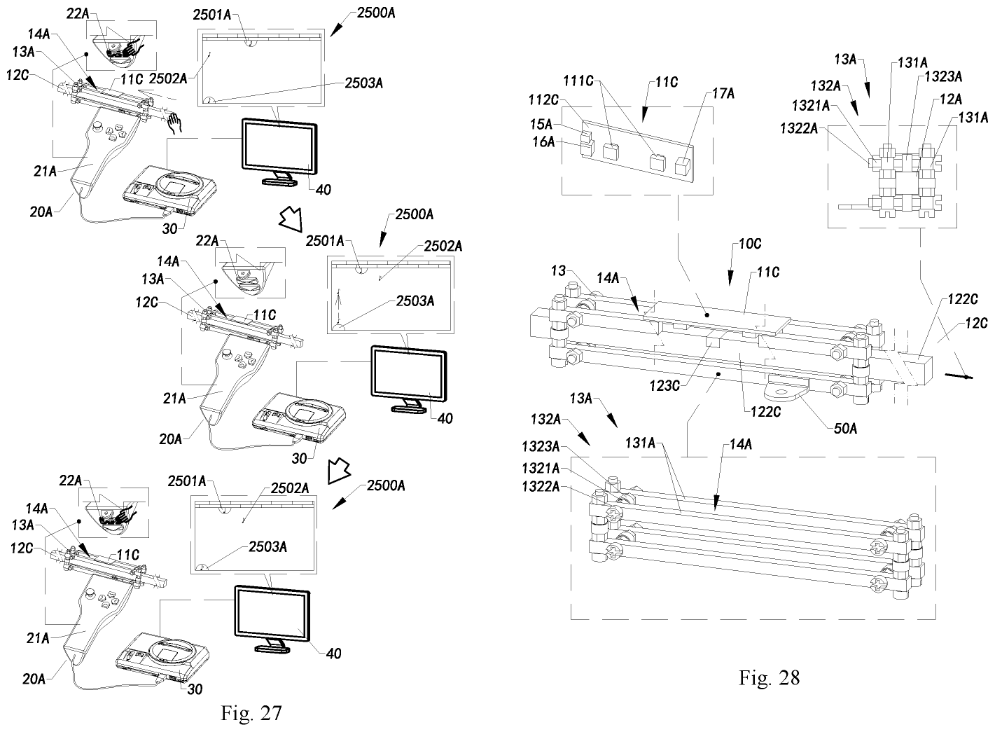

Another preferred embodiment of the invention, as shown in FIG. 25 to FIG. 27, provides a detection module 11C and an operating element 12C. The detection module 11C is arranged on one side of the detection frame 13A. The detection module 11C further comprises a magnetic induction module 111C and a substrate 112C. The magnetic induction module 111C is fixed on the substrate 112C. Preferably, the magnetic induction module 111C is oriented towards the operating element 12C. Preferably, the magnetic induction module is a Hall sensor. The operating element 12C further comprises a certain positioning part 121C, an operating part 122C and a magnetic element 123C. The magnetic element 123C is installed on the positioning part 121C, and the operating part 122C is adjacent to the positioning part 121C. The magnetic element 123C is embedded in the positioning part 121C or installed in the positioning part 121C. Preferably, the magnetic element 123C is a magnet. The user operates the operating part 122C to control the movement of the positioning part 121C in the detection frame 13A. The magnetic induction module 111C is arranged on one side of the operating element 12C. An interval is arranged between the operating element 12C and the magnetic induction module 111C. The magnetic induction module 111C is connected with a control module 23A communicatively.

During detecting, as shown in FIG. 25: said magnetic element 123C is located on the left side of said magnetic induction module 111C. The operating element 12C is moved to the right, and the magnetic element gradually approaches the magnetic induction module 111C. When the magnetic element 123C enters the detecting range of the magnetic induction module 111C, the magnetic induction module 111C generates different signals according to the direction and magnitude of the detected magnetic field, and then transmits the generated signals to the control module 23A. Transmitted to the host computer 30 through the control module 23A. For example, The detecting range of the magnetic induction module 111C is 50 mm (mm). The magnetic element 123C moves to the right from the left end of the magnetic induction module 111C. The magnetic element 123C enters the detecting range of the magnetic induction module 111C. The magnetic element 123C outputs a digital signal every 5 mm. For example, when the magnetic element 123C just enters the detecting range, the magnetic induction module 111C generates a digital signal “1” and transmits it to the control module 23A. The magnetic element 123C moves 5 mm to the right, and the magnetic induction module 111C generates a digital signal “2”. The magnetic element 123C continues to move 5 mm to the right, and the magnetic induction module 111C generates a digital signal “3”. The control module 23A marks the axial movement of the operation element 12C corresponding to the control module 23A by receiving the digital signal 1, 2 and 3. In this embodiment, the operating element controls linear motion of the X axis. The control module 23A marks the digital signals 1, 2 and 3 as displacement signals X1, X2 and X3. The control module 23A transmits displacement signals X1, X2 and X3 to the host computer 30. The cursor corresponding to the host computer 30 control moves X1, X2 and X3 in the direction of the X axis. If the operating element controls linear motion of the Y axis, the control module 23A marks the Y-axis mark. For example, mark digital signal 1 as Y1. Different position signals are output by setting the magnetic element 123C at different positions within the detecting range of the magnetic induction module 111C. The position signal is further marked by the control module 23A. The host computer 30 analyzes different position signals and then displays them on a display screen. In such a manner, the movement of the cursor on a display screen can be controlled by the operating element 12C.

It is worth mentioning that the detecting range of the magnetic induction module 111C can be expanded by increasing the number of the magnetic induction module 111C. As shown in FIG. 28, two magnetic induction modules 111C are respectively installed on the substrate 112C. The two magnetic induction modules 111C are arranged at intervals so that the detecting ranges of the two magnetic induction modules 111C are adjacent but not coincident. The control module 23A pair respectively identifies the two magnetic induction modules 111C for identifying signals from the two magnetic induction modules 111C. For example, the detecting range of digital signals for one of the magnetic induction modules 111C is defined as 1 to 10. A digital signal in the detecting range of the other magnetic induction module 111C is defined as 11 to 20. The control module 23A further adds shaft markings. For example, add “X” to the control of the X axis and “Y” to the control of the Y axis. Technical personnel in this field should understand that the output of digital signals by linear Hall sensor module according to the size of the magnetic field is the prior art. This application will not be discussed in detail.

The displacement detection device in this embodiment has a magnetic induction module as its detection module, and a magnetic element is arranged on the operating element. Different position of the operating element in the detection channel, the detection module can sense different signals. The signal can be converted into a displacement signal by the control module, so the detection module can also achieve the purpose of controlling the cursor movement on the screen by the method of position detection.

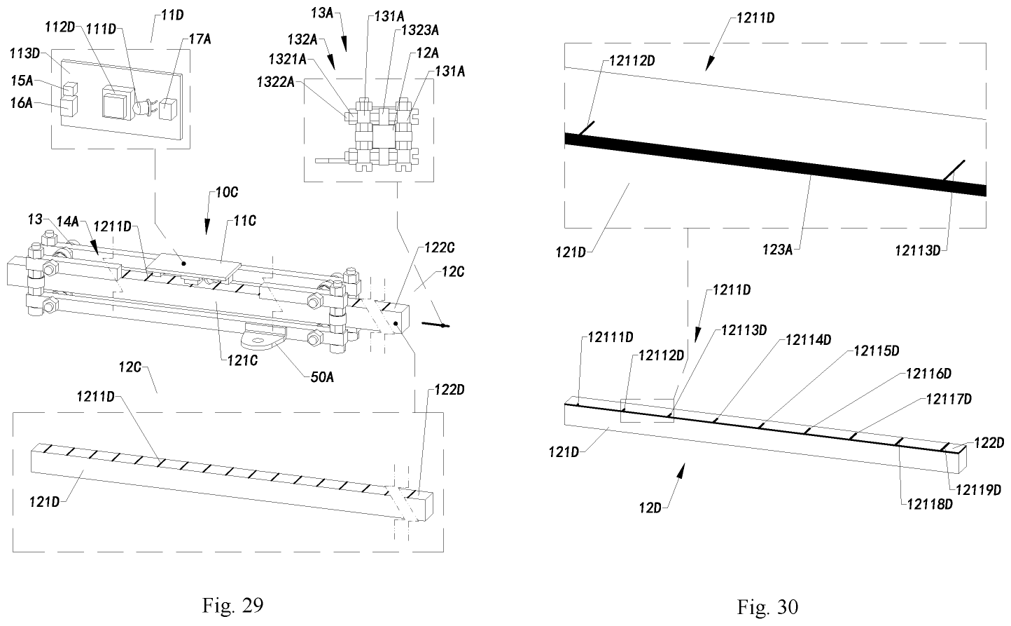

As shown in FIG. 29, another preferred embodiment of the invention provides a detection module 11D and an operating element 12D. The detection module 11C is arranged on one side of the detection frame 13A. The detection module 11D is installed on one side of the detection frame 13A. The detection module 11D is arranged on one side of the detection channel 14A. The detection module 11D further comprises a light source 111D, a camera module 112D and a substrate 113D. The light source 111D and the camera module 113D are respectively installed on the substrate 113D. The camera module 113D connects with the control module 23A communicatively. Preferably, the light source 111D is a light-emitting diode. The camera module 112D is implemented as OV7620 camera module of Ommivision Company. One of the surfaces of the operating element 12D is provided with a set of positioning markers 1211D. The group of positioning markers 1211D is set at intervals. Preferably, the intervals between the positioning markers 1211D is equal. The operating element 12D further comprises a positioning part 121D and an operating part 122D. The operating part 122D is adjacent to the positioning part 121D. Preferably, the set of location marker 1211D was set in 121D of the location part. Wherein, the positioning part 121D is covered within the shooting range of the camera module 112D. During the operation of the operating element 12D, at least one of the positioning marks 1211D is kept within the shooting range of the camera module 112D. It is worth mentioning that each of the positioning markers 1211D is not the same. The camera module 112D compares two adjacent images to determine the displacement of the positioning part 121D.

The invention provides a method for determining displacement by a displacement detection module 12D, comprising the following steps:
D1: obtain an image, wherein the image comprises at least a positioning marks 1211D, and the image is regarded as an original image.
D2: Determine the number of the positioning mark 1211D in the original image and its position in the original image, wherein, the number of the positioning mark 1211D in the original image and the position of each positioning mark are taken as the comparison parameters of the original image.
D3: Acquire another image at a preset interval and use the other image as a comparison image.
D4: Determine the number of the positioning mark 1211D in the comparison diagram and its position on the comparison diagram to serve as the comparison parameter of the comparison diagram.
D5: By comparing the original image with the comparison image, select the positioning mark 1211D which appearing in both the comparison parameters of the original image and the comparison parameters of the comparison image as the comparison target.
D6: Compare the position of the comparison target in the original image and the comparison image respectively to get the movement direction and displacement of the comparison target.
D7: Generates a moving signal according to the movement direction and displacement of the comparison target, wherein the moving signal is sent to the control device 23A, wherein, if the comparison target does not move, a stationary signal is generated, and the stationary signal is sent to the control device 23A.
D8: Use the comparison image as the original image, and use the comparison parameters of the comparison image as the comparison parameters of new original image.
D9: go to Step D3.

As shown in FIG. 30, specifically, the positioning part 121D is provided with nine line segments of different lengths as positioning mark 1211D. The nine line segments are arranged in the positioning part 121D at intervals from short to long and from left to right, and are defined as 12111D, 12112D, 12113D, 12114D, 12115D, 12116D, 12117D, 12118D and 12119D, respectively. When the operating element 12D begins to move, the light source 111D is turned on to provide illumination. The camera module 112D obtains an image. The image comprises a location marker 12111D. A location marker 122111D, at the far right of the image, is defined as the original image comparison parameter. The operating element 12D continues to move to the left. The camera module 112D takes another image as a comparison image. The camera module 112D determines that two positioning marks 12111D and 12112D appear on the right side of the comparison image. The camera module 112D determines the rightmost part, and the two positioning marks are used as the comparison parameters of the comparison image. The camera module 112D compares the comparison parameters of the original image and the comparison parameters of the comparison image. Further, the camera module 112D selects the positioning mark 12111D, which appearing in both the comparison image and the original image, as the comparison target. The camera module 112D compares the position of the contrast object in the original image and the comparison image respectively, then the moving direction and displacement of the contrast object can be obtained to generate a moving data. The moving data is sent to the control module 23A to generate a displacement data and sent to the host computer 30. If the camera module 112D compares the comparison target with the original image and the comparison image respectively, a static data is generated and sent to the control module 23A. The control module 23A further transmits static data to the host computer. It is worth mentioning that the control device 23A further comprises a conversion module 237A to provide conversion between linear displacement and angular displacement. The conversion module 237A presets a conversion threshold. If the displacement is 5 mm, rotate 5 degrees. The displacement direction of the conversion module 237A is defined as the direction of rotation. If it moves to the left, it will be converted to the left. Moving to the right is turning to the right. In this way, for controlling racing games.

The displacement detection device 10A further comprises a connecting interface 15A. The connecting interface 15A is electrically connected to the detection module 11A. Power and/or transmit data to the detection module 11A by the controller 20A of the connecting interface 15A. In other words, the detection module 11A transmits signals to the controller 20A by the connecting interface 15A. The controller 20A provides electrical energy to the detection module 11A by the connecting interface 15A.

It is worth mentioning that the displacement detection device 10A provides another connection mode with the controller 20A. The displacement detection device 10A further comprises a communication device 16A and a power supply device 17A. The power supply device 17A is electrically connected with the light source 111A, the optical engine 113A and the communication device 16A. The communication device 16A is communicated to the controller 20A.

The operating element 12A further comprises a positioning part 121A and an operating part 122A. The operating part 122A is adjacent to the positioning part 121A. The operating part 122A is held by the user to control the movement of the positioning part 12A on the detection frame 13A. The positioning part 121A further defines a positioning surface 1211A. At least a positioning mark 12111A is further set on the positioning surface 1211A. Adjacent to the two positioning markers 12111A are provided with the equal interval. It is worth mentioning that the positioning part 121A further comprises a cushion body 123A. Preferably, the cushion body 123A is fixed on the side of the control lever 121A facing the detection module 11A to prevent the surface of the control lever 121A from affecting the positioning of the detection module 11A by light reflection and refraction, thus making the positioning more effective.

The game controller having a displacement detecting device further comprises a displacement detecting device connector 50A. The displacement detecting device connector 50A is respectively connected with the controller 20A and the displacement detection device 10A. Preferably, the displacement detection device connector 50A is a universal connector.

The controller 20A further comprises a housing 21A, at least an input device 22A and a control module 23A. The input device 22A is arranged on a surface of the housing 21A. The control module 23A is arranged in the housing 21A. The input device 22A is connected with the control module 23A communicatively. The input device 22A is a button and/or a joystick. The input device 22A transmits an input operation signal to the control module 23A. The control module 23A is connected with a host computer communicatively. The control module 23A transmits the operation signal to the host computer. The detection module 11A is connected with the control module 23A communicatively. The detection module 11A transmits the displacement signal to the control module 23A. The control module 23A transmits the displacement signal to the host computer. The housing 21A further comprises an input part 211A and a holding part 212A. The input part 211A is adjacent to the holding part 212A. The holding part 212A is for the user to hold. The input device 22A is arranged at the input part 211A. Preferably, the user can operate the input device 22A with his thumb.

The control module 23A further comprises a processing module 231A and a communication module 232A. The processing module 231A connects with the communication module 232A communicatively. The processing module 231A is respectively connected with the detection module 11A and the input device 22A communicatively. The detection module 11A transmits the displacement signal to the processing module 231A. The input device 22A transmits the operation signal to the processing module 231A. The processing module 231A transmits the displacement signal and the operation signal to the host computer 30 by the communication module 232A to control the operation and movement of the corresponding target. The control module 23A further comprises an initialization module 233A. The initialization module 233A connects with the processing module 231A communicatively and the communication module 232A respectively. A game controller with a displacement detection device of the invention is connected to a host computer 30, and the initialization module 233A is started to initialize the game controller with a displacement detection device of the invention. The initialization module 233A obtains the performance parameters of the host computer by the communication module 232A, such as host computer model, processor frequency, memory capacity and other parameters. The initialization module 233A further obtains the parameters of processing module 231A. The initialization module 233A determines the frequency of transmitting operation signals and or displacement signals to the host computer according to the performance parameters of the host computer and the processing module 231 parameters. It is worth mentioning that the frequency at which the processing module 231A transmits an operational signal or a displacement signal to the host computer is defined as the reporting rate. For example, if the reporting rate of the processing module 231A is 125 Hz, it means that the processing module 231A sends an operation signal to the host computer every 8 ms. If in the game, such as the last send time is 1 ms, the operation of the game. Then there is 7 ms before the next operation signal is sent, In other words, the delay time is 7 ms. The processing module 231A provides a 1000 hz reporting rate so that the delay can be controlled at 1 ms. However, the greater the reporting rate, the greater the load on the processor of the host computer 30. Therefore, the initial module 233A is used to coordinate the reporting rate with the host computer 30 to improve the game experience. Preferably, the processing module 231A supports a report rate of 500 Hz or 1000 Hz. The initialization module 233A further obtains the resolution of the display by the host computer 30. The initialization module 233A obtains DPI (Dot Per Inch) of the detection module 11A. The DPI refers to the number of pixels of the screen which the cursor is controlled when the operating element 12A moves 1 inch in the detection frame. The initialization module 233A optimizes the DPI of the detection module 11A according to the resolution of the display screen and the length of the positioning part 121A of the operating element to improve the game experience.

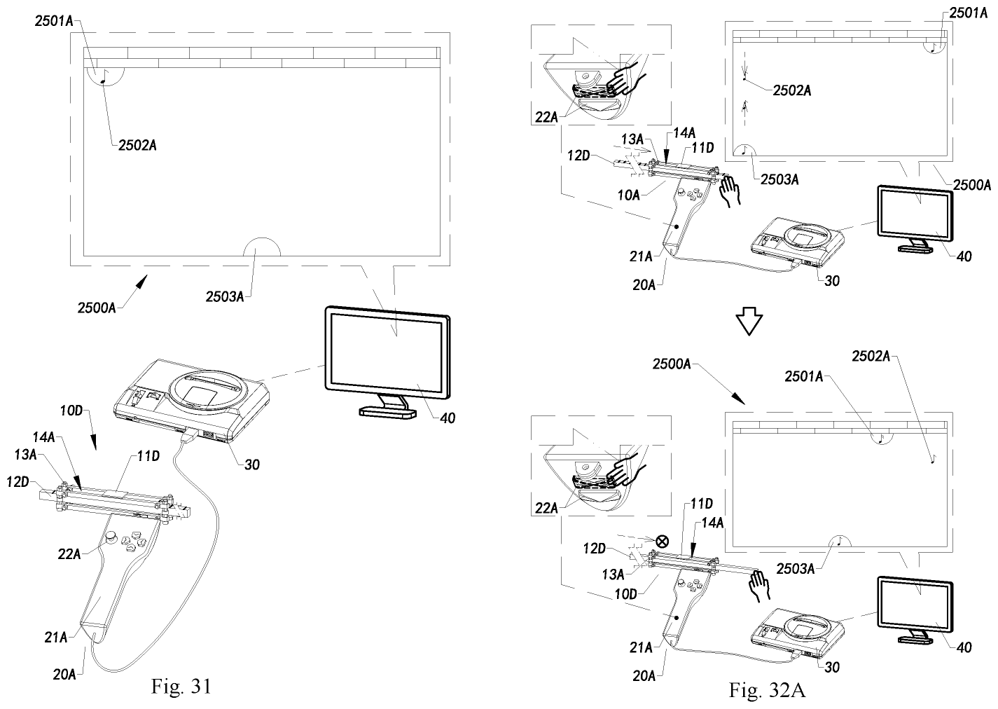

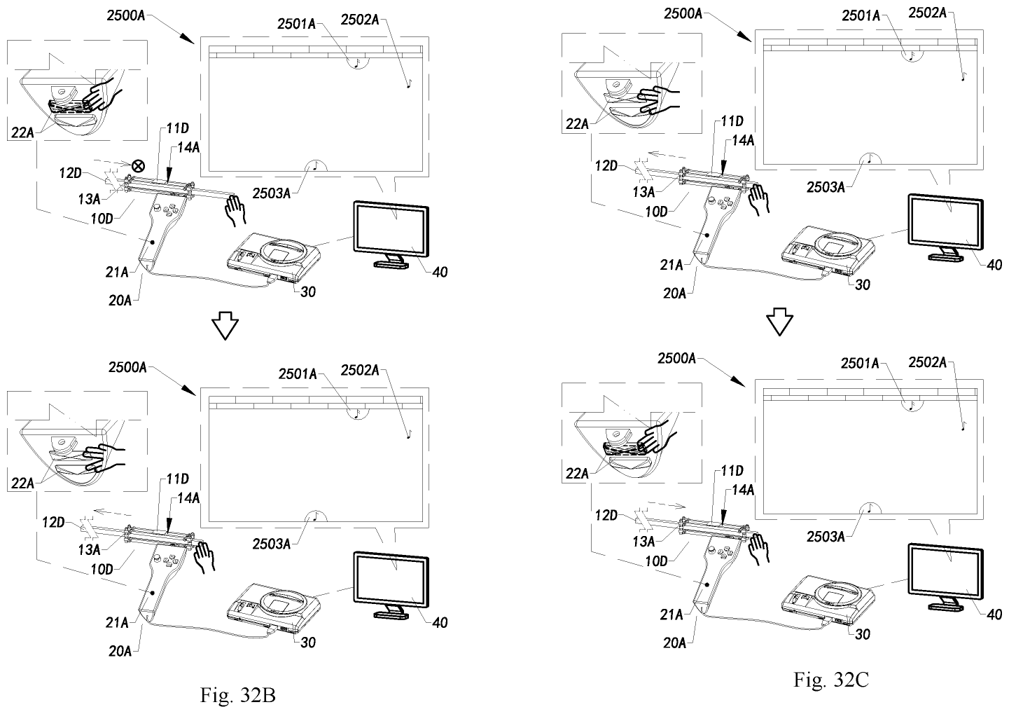

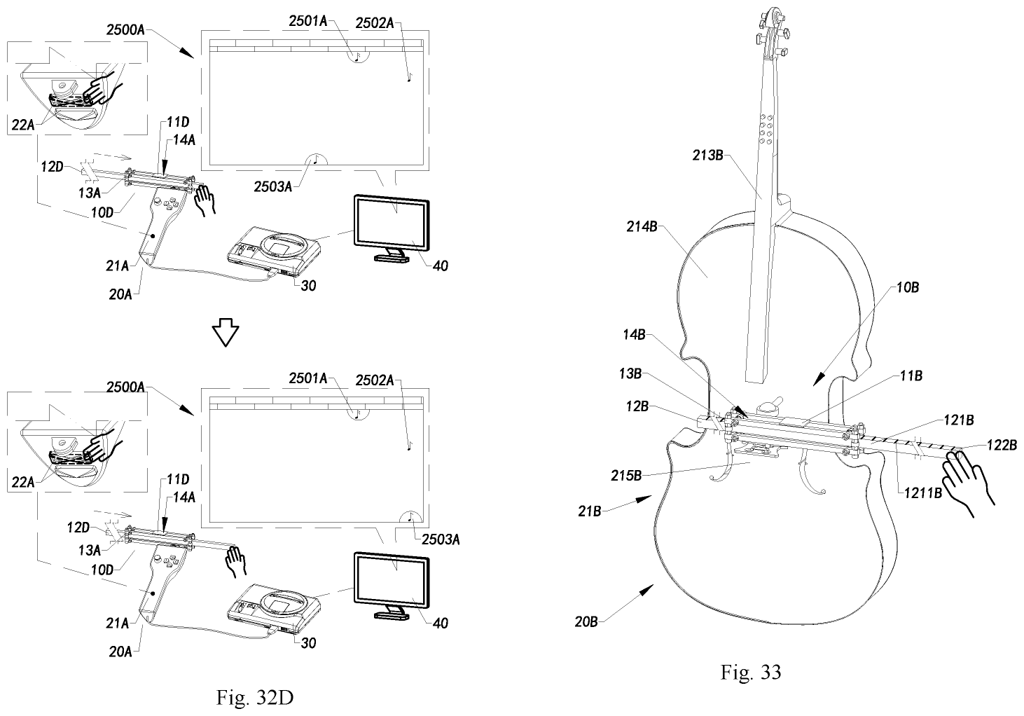

The initialization module 233A further comprises a user configuration module 2331A for storing a practice game data. By running the practice game data, the user can learn the use method of the game controller with a displacement detection device of the invention, and at the same time, the initialization module 233A learns the user's using habits. FIG. 31 shows the game interface of a practice game. In a preferred embodiment of the invention, the practice game data is a note elimination game. A game interface 2500A of the note elimination game is shown in FIG. 31. At the top of the game interface 2500A is a note drop section 2501A. The note 2502A in the note drop section 2501A appears randomly anywhere on top of the game interface 2500A. Then the note 2502A moves down the screen. There is a eliminating cursor 2503A at the bottom of the game interface 2500. The operating element 12A controls the horizontal movement of the eliminating cursor 2503A. When the eliminating cursor 2503A makes contact with the note 2502A, the note 2502A disappears. In such a manner, the user learns to control the eliminating cursor 2503A using the operating element 12A. FIG. 32A to FIG. 32D shows the musical play process.

It is worth mentioning that when the initialization module 233A sends the notes to the host computer to run the note elimination game, the initialization module 233A obtains the performance parameters of the host computer to coordinate the reporting rate of the processing module 231A. During the game, the note 2502A can be randomly generated and dropped at a certain distance. The user controls the horizontal movement of the eliminating cursor 2503A by operating the movement speed of the operating element 12A to eliminate the note 2502A falling down. During the game, the initialization module 233A learns the movement speed of the user to control the operating element, so as to adjust the DPI of the displacement detection module 11A, so as to optimize the game experience.

It is worth mentioning that if the operating element 12A cannot control the elimination cursor 2503A to move from one side to the other side of the game interface 2500A during a horizontal movement. The note elimination game provides a way to learn a using method of a reset button 221A. Specifically, the host computer runs the note elimination game. Two notes 2502A are formed at each end of the top of the game interface 2500A. The two notes 2502A fall at intervals. The user operates the operating element 12A, After eliminating one of the notes 2502A, the user controls the eliminating cursor 2503A by operating the operating element 12A to move to the other side of the game interface 2500A to eliminate another note 2502A. The positioning part 121A of the operating element 12A moves from one end to the other end. When the positioning part 121A is moved to the other end, the elimination cursor 2503A is moved to the middle of the game interface 2500A. At this time, when the detection module 11 detects that the positioning part 121A has been moved to the other end, and sends a reset signal to the processing module 231A. The processing module 231A sends the reset signal to the host computer by the communication module 232A. According to the reset signal received by the host computer, a reset prompt message is displayed on the game interface 2500A to prompt the user to operate the reset button 221A. The user operates the reset button 221A. The processing module 231A receives the signal that the reset button 221 is operated, and suspend the work of the displacement detection module 11A. At this time, the user moves the positioning part 121A of the operating element 12A back to the end from the other end. The user stops operating the reset button 221A, and the processing module 231A restores the working state of the displacement detection module 11A. The user operation the operating element 12A will control the movement of the elimination cursor 2503A to the other side of the user interface 2500A. It is worth mentioning that the initialization module 233A records the movement mode and speed of the operating element 12A when the user is playing the game. The initialization module 233A forms a user configuration file according to recorded parameters such as the moving mode and moving speed of the operating element 12A operated by user, obtained performance parameters of the host computer and the obtained resolution of the display screen, optimized DPI of the displacement detection module 11A, and the reporting rate of the processing module 231A. The user configuration file is stored in the user configuration file module 2331A. On the next use of a game controller with a displacement detection device of the invention, the initialization module 233A determines whether the host computer and display are consistent with the last time. If so, the initialization module obtains the user configuration file and optimizes according to the user configuration file.

FIG. 33 shows another preferred embodiment of a game controller with a displacement detection device of the present invention. This application for a game controller with a displacement detection device further comprises a displacement detection device 10B and a controller 20B. The displacement detection device 10B is connected with the controller 20B communicatively. The controller 20B further comprises a housing 21B, at least an input device 22B and a control module 23A. The displacement detection device 10B is embedded on the surface of the housing 21B. Preferably, the housing 20B is shaped like a violin. The housing 20B further comprises a violin neck 213B, a panel 214B and a violin bridge part 215B. The violin neck 213B is arranged at one end of the panel 214B.

The plano violin bridge part 215B is arranged in the middle of the panel 214B. The displacement detection device 10B is embedded in the plano violin bridge part 215B. The input device 23B is arranged on the violin neck 213B. The control module 23B is arranged in the housing 21B. The displacement detection device 10A is connected with the control module 23B communicatively. The control module 23B is connected with a host computer communicatively to transmit the displacement data detected by the displacement detecting device 10B to the host computer by the control module 23B. The game controller with the detection module in this embodiment preferably controls the music game. The displacement detection device 10B further comprises a detection module 11B, a displacement detection frame 13B and an operating element 12B. The detection module 11B and the displacement detection frame 13B are arranged on the housing 20B. The displacement detection frame 13B defines a detection channel 14B in the middle of the displacement detection frame 14B. The operating element 12B moves axially to the ground in the detection channel 14B. The detection module 11B is arranged on one side of the displacement detection frame 13B. Preferably, the displacement detection frame 13B is arranged at the violin bridge part 213B. The operating element 12B passes through the detection channel 14B. The operating element 12B further comprises a positioning part 121B and an operating part 122B. The positioning part 121B is adjacent to the operating part 122B. The positioning part 121B can be set with at least a positioning mark 1211B for detecting by the displacement detection module 11B. Preferably, the input device 22B is a set of buttons 221B. The button 221B is arranged on the violin neck 213B. The 221B button is used to simulate the pressing of strings. At the same time, the operating element 112B is operated to simulate the action of pulling strings. The detection module 11B detects the displacement of the operating element 12B. The detection module 11B sends a displacement signal to the control device 23B during the axial movement of the operating element 112B. The control module 23B transmits the received button signal and displacement signal to the host computer, and the host computer simulates the sound produced by playing the violin.

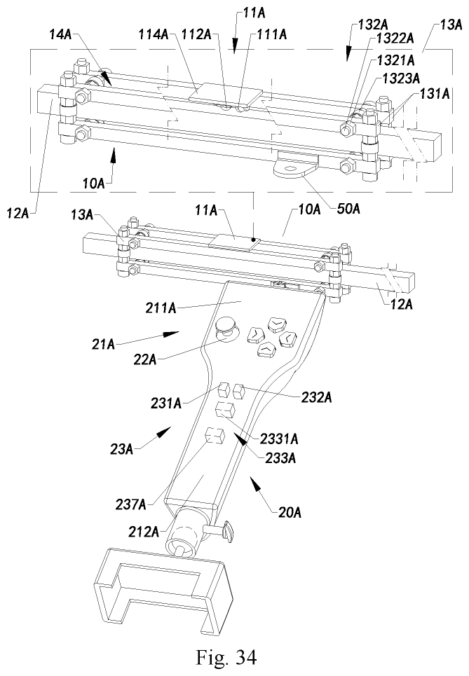

As shown in FIG. 34, the game controller with a displacement detection device of the invention further comprises a stabilizer 60A, which is mounted at the bottom of the controller 20A. The stabilizer 60A further comprises a stabilizer connector 61A and a support part 62A. The stabilizer connector 61A is movably connected to the retainer part 62A. When operating the game controller with a displacement detection device of the invention, the support part 62A is reachame body to increase the support of the body to the controller 60A, so as to make the game controller with a displacement detection device of the invention more stable.

What is claimed is:

1. A game controller with a displacement detection device, comprising:
a controller comprising:
a housing;
at least one input device arranged at the surface of said housing; and
a control device arranged inside said housing and connected to said input device communicatively; and
a displacement detection device connected to said control device communicatively, wherein said displacement detection device further defines a detection channel, and comprises a detection module and a positioning device, wherein said detection module is arranged on one side of said detection channel and connected to said control device communicatively, wherein said positioning device is moved axially by said detection channel to generate at least one displacement data, which is transmitted to said control device for said control device to provide displacement control based on at least one said displacement data.

2. The game controller with a displacement detection device, as recited in claim 1, wherein said detection module is arranged in said housing, wherein said detection channel is formed in said housing, and said detection channel runs through the opposite sides of said housing for said positioning device to move axially in said detection channel.

3. The game controller with a displacement detection device, as recited in claim 1, wherein said displacement detection device is arranged outside said housing, wherein said displacement detection device further comprises a detection frame, and said detection channel is defined in said detection frame, said detection channel runs through said detection frame so that said positioning device passes through said detection frame and move axially, wherein said detection module is arranged on one side of said detection frame for detecting the displacement of said positioning device in said detection frame for axial ground movement.

4. The game controller with a displacement detection device, as recited in claim 3, wherein said detection frame is a detection catheter.

5. The game controller with a displacement detection device, as recited in claim 3, wherein said detection frame is set as a cuboid, wherein said detection frame further comprises two channel opening frame, and said two channel opening frame are located at two ends of said detection channel for defining two channel opening of said detection channel respectively, a guiding wheel is respectively installed on the bottom side of said two channel opening frame to make said positioning device move axially on said guiding wheel to reduce the friction force when said positioning device moves in said detection frame.

6. The game controller with a displacement detection device, as recited in claim 1, wherein said detection module is selected from either optical displacement detection module or mechanical displacement detection module.

7. The game controller with a displacement detection device, as recited in claim 1, wherein said detection module further comprises a camera module and a light emitting module, wherein said positioning device is provided with a set of positioning markers, each of the two adjacent said positioning markers have the equal interval, said set of positioning markers are different, wherein said light emitting module provides lighting so that said camera module can capture said positioning mark located on said positioning device, said camera module transmits said positioning mark when said positioning device starts to move and said positioning mark when it stops moving to said control module respectively, said camera module transmits said positioning mark when said positioning device starts to move and said positioning mark when it stops moving to said control module respectively, said control module according to the photo of said positioning mark and shooting time when said positioning device starts to move, and the photo of said positioning mark and shooting time when it stops moving, and the displacement of said positioning device obtained according to the interval between two adjacent said positioning marks.

8. The game controller with a displacement detection device, as recited in claim 1, wherein said detection module further comprises a magnetic induction module, and said positioning device is provided with a magnetic device, wherein said magnetic device is limited to move axially in said detection channel, wherein said magnetic induction module transmits the direction and magnetic force value to said control module, and said control module obtains the displacement of said positioning device according to the detected magnetic field direction and magnetic force value.

9. The game controller with a displacement detection device, as recited in claim 1, wherein said positioning device further comprises a positioning part and an operation part, said positioning part is adjacent to said operation part, wherein said positioning part moves axially in said detection channel, wherein said operation part is for helding by the user to operate said positioning part axially.

10. The game controller with a displacement detection device, as recited in claim 1, wherein said input device further comprises a reset button, which is connected to said control device communicatively, wherein said control device controls said detection module to pause detecting the displacement of said positioning device in said detection channel when said reset button is pressed.

11. The game controller with a displacement detection device, as recited in claim 1, wherein said control module further comprises a processing module and a communication module, wherein said processing module is respectively connected to said communication module, said detection module and said input device communicatively, and said processing module processes the data acquired by the detection module into displacement data, said processing module processes the date obtained by said input device into operational data, wherein said communication module is connected with a host computer to transmit said displacement data and said operating data to the said computer.

12. The game controller with a displacement detection device, as recited in claim 11, wherein said control module further comprises an initialization module, and said initialization module is connected to said communication module communicatively and obtains the performance parameters of the host computer by said initialization module to coordinate the frequency of said displacement data transmitted to said host computer according to said performance parameters of said host computer so that computer host computer process the displacement data in real time, thereby reducing latency.

13. The game controller with a displacement detection device, as recited in claim 1, wherein said initialization module coordinates the sampling frequency of said detection module for said positioning device according to said performance parameters of said host computer.

14. The game controller with a displacement detection device, as recited in claim 13, wherein said control module further comprises a user configuration module, said user configuration module connected to said initialization module and said communication module communicatively, wherein said user configuration module stores a practice game, wherein said initialization module sends said practice game to said host computer to run through said communication module, said practice game is sent to the host computer to run, wherein, in the process of running said practice game, said the initialization module generates a user configuration file to optimize the control of said displacement detection device to the game according to obtained performance parameters of the host computer and obtained resolution of a display screen connected to said host computer, the sampling rate of said detection module to said positioning device, and the speed of learning the user to move said positioning device in the process of running said practice game.

15. A displacement detection device, used for a one-handed game controller, comprising:
a connecting device for mounting said displacement detection device at said one-handed game controller removably;
a detection frame installed in said connecting device, wherein the detection frame defines a detection channel;
a detection device arranged at one side of said detection frame;
a positioning device through said detection channel, wherein said detection device in said detection channel detects the axial displacement of said positioning device; and
a communication connecting to said one-handed game controller communicatively to transmit displacement data to said one-handed game controller.

16. The displacement detection device, as recited in claim 15, wherein said detection device is selected from a optical displacement detection device and a mechanical displacement detection device.

17. The displacement detection device, as recited in claim 15, wherein said detection device further comprises a camera module and a light emitting module, wherein said positioning device is provided with a set of positioning markers, each of the two adjacent said positioning markers have the equal interval, said set of positioning markers are different, wherein said light emitting module provides lighting so that said camera module can capture said positioning mark located on said positioning device, said camera module transmits said positioning mark when said positioning device starts to move and said positioning mark when it stops moving to said control module respectively, said camera module transmits said positioning mark when said positioning device starts to move and said positioning mark when it stops moving to said control module respectively, said control module according to the photo of said positioning mark and shooting time when said positioning device starts to move, and the photo of said positioning mark and shooting time when it stops moving, and the displacement of said positioning device obtained according to the interval between two adjacent said positioning marks.

18. The displacement detection device, as recited in claim 15, wherein said displacement detection device further comprises a magnetic induction module, and said positioning device is provided with a magnetic device, wherein said magnetic device is limited to move axially in said detection channel, wherein said magnetic induction module transmits the direction and magnetic force value to said control module, and said control module obtains the displacement of said positioning device according to the detected magnetic field direction and magnetic force value.

19. The displacement detection device, as recited in claim 15, wherein said detection frame is set as a cuboid, wherein said detection frame further comprises two channel opening frame, and said two channel opening frame are located at two ends of said detection channel for defining two channel opening of said detection channel respectively, a guiding wheel is respectively installed on the bottom side of said two channel opening frame to make said positioning device move axially on said guiding wheel to reduce the friction force when said positioning device moves in said detection frame.

20. The displacement detection device, as recited in claim 15, wherein said connection device is a universal connection device.
